(19) United States
(12) Patent Application Publication
(10) Pub. No.: US 2025/0382198 A1
(43) Pub. Date: Dec. 18, 2025

(54) ADSORBENT AND METHOD FOR REMOVING PER- AND/OR POLYFLUOROALKYL SUBSTANCES (PFAS) IN WATER MATRICES

(71) Applicant: University of Central Florida Research Foundation, Inc., Orlando, FL (US)

(72) Inventors: Ni-Bin Chang, Orlando, FL (US); A H M Anwar Sadmani, Orlando, FL (US)

(21) Appl. No.: 19/230,607

(22) Filed: Jun. 6, 2025

Related U.S. Application Data
(60) Provisional application No. 63/661,274, filed on Jun. 18, 2024.

(51) Int. Cl. C02F 1/28; C02F 1/00; C02F 101/36

(52) U.S. Cl. CPC C02F 1/283; C02F 1/001; C02F 2101/36

(57) ABSTRACT

Described herein relates to a multicomponent filtration medium and system that may be used for the removal of per- and/or polyfluoroalkyl substances (PFAS) from water. The filtration medium can comprise a granular mixture including biochar, perlite, sand, clay, and/or zero-valent iron (ZVI), such that the combined composition may facilitate synergistic adsorption through mechanisms including hydrophobic interaction, electrostatic attraction, and/or ligand exchange. The media can be used in packed-bed, gravity-fed systems configured for ex situ and/or in situ treatment. In certain configurations, the system may provide spatial separation of PFAS compounds by chain length and/or polarity, such that long-chain species can be retained in upstream regions and/or short-chain species may migrate further into the bed. The system can be applied to groundwater and/or surface water sources, and/or may be tailored to operate under varying water chemistry conditions. Performance metrics can include compound-specific breakthrough curves and/or adsorption capacity values under flow-through operation.

### CROSS-REFERENCE TO RELATED APPLICATIONS

This Nonprovisional patent application claims the benefit of and priority to U.S. Provisional Patent Application No. 63/661,274 entitled “ADSORBENT AND METHOD FOR REMOVING PER-AND/OR POLYFLUOROALKYL SUBSTANCES (PFAS) IN WATER MATRICES” filed Jun. 18, 2024, by the same inventors, all of which is incorporated herein by reference, in its entirety, for all purposes.

### BACKGROUND OF THE INVENTION

### 1. Field of the Invention

This invention relates, generally, to filtration media. More specifically, it relates to an adsorbent and method for performing targeted removal of per- and/or polyfluoroalkyl substances (PFAS) (e.g., Perfluorooctanoic acid (PFOA), perfluorooctanesulfonic acid (PFOS), perfluorobutanoic acid (PFBA), and/or perfluorobutane sulfonic acid (PFBS)) in water matrices (e.g., surface water and/or groundwater).

### 2. Brief Description of the Prior Art

Per- and polyfluoroalkyl substances (hereinafter “PFAS”) have been used since the 1940s in various industrial products including cleansers, fabrics, leather, paper, paints, flame-combating foams, and wire insulation [1,2]. The extensive applications of PFAS in the consumer and industrial products can be attributed to their unique physicochemical properties including chemical stability and inertness [3,4], water and oil repellency [5,6], high heat resistance [6], and low surface energy [7]. While multiple strong carbon-fluorine (C—F) bonds render PFAS the expected functionalities, there are environmental and human health consequences of such strong bonding. PFAS contamination has been extensively documented in the groundwater, surface water bodies, and in some cases, even in drinking water [8-11]. A recent study on the occurrence and distribution of PFAS in the Indian River Lagoon (IRL) has reported elevated total PFAS (up to 265 ng/L) in the Banana River, most likely due to industrial discharge and extensive use of aqueous film-forming foams in the past [12]. Up to 166 ng PFOS/g wet mass of manatee was detected in plasma of the threatened West Indian manatee sampled from critical manatee habitats in Florida [13].

PFAS exposure may elicit an elevation in cholesterol levels [14], damage liver function [15], disrupt thyroid hormone regulation [16], and give rise to bladder carcinogenesis [17]. The import and production of long-chain PFAS have been subjected to regulatory measures in the United States [18]. Analogous to their long-chain counterparts, short-chain PFAS may also lead to transformation products in the environment, exhibiting higher solubility in aqueous media and lower potential for sorption onto particulate matter compared to their long-chain analogs [19]. However, there is a general lack of awareness of the environmental and health hazards of short-chain PFAS. Kidney dysfunction and liver diseases have been reported to be associated with exposure to short-chain PFAS [20, 21]. Hexafluoropropylene oxide dimer acid (hereinafter “HFPO-DA”) (also referred to as GenX chemicals) and PFOA may exhibit divergent mechanisms of toxicity in the embryo-placenta region [22], while perfluorobutane sulfonic acid (PFBS) can lead to stronger and potential developmental toxicity compared with perfluorobutanoic acid (PFBA) [23]. Due to the growing concerns regarding human health, ecosystem integrity, and water quality, the U.S. Environmental Protection Agency (EPA) has recently announced the National Primary Drinking Water Regulations for six PFAS, including PFOA, PFOS, perfluorononanoic acid (PFNA), GenX, perfluorohexanesulfonic acid (PFHxS), and PFBS [24]. The Maximum Contaminant Levels (MCLs) for PFOA and PFOS are set at 4 ppt (ng·L⁻¹) and those for PFHxS, PFNA, and HFPO-DA (GenX) are set at 10 ppt (ng·L⁻¹). For this reason, source water pretreatment for PFAS removal has become an emerging task to reduce the workload of final PFAS removal for all drinking water treatment process. For instance, when considering color removal for large-scale interbasin water transfer in a drinking water treatment system [25]. PFAS removal using cost-effective specialty adsorbents had better be included as a pretreatment for the source water protection from contamination to help avoid the need for complex drinking water treatment and reduce total treatment costs such as the case in Islam et al. [26].

Owing to their unique chemical properties such as high hydrophilicity, mobility, and solubility, PFAS are not effectively removed by conventional water treatment processes (e.g., the coagulation, flocculation, and sedimentation processes) [27]. Other water treatment technologies including granular activated carbon (GAC), ion exchange, and high-pressure membrane filtration have been employed to remove PFAS [28]. For instance, PFOS is more readily adsorbed by activated carbon when compared to PFOA [29]. Since hydrophobicity increases with increasing C—F chain length, long-chain PFAS are more likely to be adsorbed compared to short-chain congeners [30]. However, the exhausted GAC media must be regenerated or transferred to a landfill or an incinerator for combustion at temperatures greater than 1,000° C. [31]. Nanofiltration (NF) and reverse osmosis (RO) can effectively remove long-chain PFAS [31], with a removal rate exceeding 99% for RO and between 90% and 99% for NF [32]. However, NF and RO treatment are quite energy-intensive and costly. Recent efforts have been directed towards developing specialty adsorbents to reduce costs, such as modified activated carbons (H₃PO₄) [33], commercial Douglas fir biochar with or without Fe₃O₄ [34], and reed straw-derived biochar for use in the drinking water treatment process.

Green sorption media (GSM), composed of a mixture of recycled and natural material, have demonstrated potential for cost-effective, scalable, adaptable, and sustainable fit-for-purpose applications to remove PFAS at the source water location as a pre-treatment for conventional drinking water treatment (i.e., coagulation, flocculation, sedimentation, filtration, and disinfection) [36]. These GSM have shown the potential for PFOS removal through the applications of clay-tire crumb-sand (CTS), iron filings-based green environmental media (IFGEM), clay-perlite-sand (CPS), as well as zero-valent iron (ZVI) and perlite-based green environmental media (ZIPGEM), as shown in TABLE 1, provided below [37-38]. A recently completed field-scale study using CPS and ZIPGEM near the IRL confirmed similar results [36]. However, CPS, CTS, IFGEM, and ZIPGEM were unable to consistently remove both long-chain-chain PFOA and PFOS simultaneously, indicating a need for further improvement.

TABLE 1

| | Media | BET | | | Saturated |
|---|---|---|---|---|---|
| | Matrix | Surface | | | Hydraulic |
| | by | Area | Density | Porosity | Conductivity |
| Media | Volume | (m² · g⁻¹) | (g · cm⁻³) | (%) | (cm s⁻¹) |
| CTS | 85% sand, 10% tire | 0.86 | 2.40 | 40.10 | 0.026 |
| | crumb, and 5% clay | | | | |
| IFGEM | 91% sand, 5% ZVI, and | 3.11 | 2.72 | 29.19 | 0.013 |
| | 4% clay | | | | |
| CPS | 92% sand, 5% clay, and | 1.08 | 2.61 | 26 | 0.017 |
| | 3% perlite | | | | |
| ZIPGEM | 85% sand, 5% clay, 5% | 1.50 | 2.78 | 33 | 0.028 |
| | ZVI, and 5% perlite | | | | |
| BIPGEM | 80% sand, 5% biochar, | 1.35 | 2.54 | 30 | 0.012 |
| | 5% clay, 5% perlite, and | | | | |
| | 5% ZVI | | | | |

Accordingly, what is needed is an effective, efficient, economically viable, scalable, adaptable, and/or sustainable adsorbent and methods thereof for removing PFAS from water matrices. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to filtration medium treating water matrices. In embodiments, the filtration medium may comprise the following: (a) biochar; (b) perlite; (c) sand; and/or (d) zero-valent iron (ZVI). In these embodiments, the filtration media may be configured to remove a plurality of substances. In this manner, the plurality of substances may also comprise such that the plurality of substances comprise per- and/or polyfluoroalkyl substances (PFAS), perfluorooctanesulfonic acid (PFOS), perfluorobutanoic acid (PFBA), and/or perfluorobutane sulfonic acid (PFBS)). In addition, in these embodiments, the plurality of substances can comprise varying chain lengths and/or polarities, such that the filtration media may target at least one of the plurality of substances by at least hydrophobic interaction, electrostatic attraction, and/or ligand exchange.

In some embodiments, the biochar may have a point of zero charge greater than 9.0. In these other embodiments, the biochar may also comprise a BET surface area of at least 300 m²/g. In this manner, biochar can be derived from hardwood biomass subjected to pyrolysis.

In some embodiments, the zero-valent iron (ZVI) may be derived from recycled iron filings. In some embodiments, the sand may also comprise from 60% to 90% by weight of the total composition. As such, the filtration medium may also further comprise clay configured to provide pH buffering between pH 6.5 and 7.5. In these other embodiments, the pH-buffering effect may be sufficient to maintain bed pH stability for at least 24 hours of flow-through operation. The ZVI can also provide local reducing conditions favoring ligand exchange with PFAS compounds.

Moreover, another aspect of the present disclosure pertains to a method for treating water matrices. In embodiments, the method may comprise the following: (a) directing water matrices through a packed bed comprising a granular mixture of adsorptive materials, in which the adsorptive materials may comprise biochar, perlite, sand, clay, and/or ZVI. In these embodiments, the water matrices can comprise a plurality of substances, including both long-chain and short-chain lengths, such that the plurality of substances may comprise PFAS, in which perfluorooctanesulfonic acid (PFOS), perfluorobutanoic acid (PFBA), and/or perfluorobutane sulfonic acid (PFBS)) are two major chemical species of concern. As such, in these embodiments, at least one of the plurality of substances may be retained by the packed bed by a combination of hydrophobic, electrostatic, and/or ligand-exchange interactions, and/or the packed bed may be operated under gravity-fed flow conditions without external pressurization.

In some embodiments, at least one of the plurality of long-chain substance may be retained in an upper portion of the packed bed and/or at least one of the plurality of short chain substance may be configured to migrate downstream to a lower portion of the packed bed. Additionally, the packed bed can be installed in a downflow vertical column. In this manner, the packed bed can be compositionally homogeneous across its depth.

In some embodiments, a mobility and/or a spatial separation of the plurality of substances may be confirmed by segmental sampling of the bed after use. In these other embodiments, the sand can also comprise from 60% to 90% by weight of the total composition. In addition, the water may comprise background ionic species that enhance the retention of at least one of the plurality of substances by the adsorptive materials. In some embodiments, the packed bed may be installed within a removable treatment cartridge.

Furthermore, an additional aspect of the present disclosure pertains to a filtration system. In embodiments, the filtration system may comprise the following: (a) a vertically oriented housing having an inlet and an outlet; and/or (b) a packed bed disposed within the housing, the packed bed comprising a homogeneous or layered bed of biochar, perlite, sand, clay, and/or ZVI. In these embodiments, a plurality of substances comprising a plurality of chain lengths can be retained at varying depths within the packed bed during flow-through treatment, such that at least one of the plurality of substances comprising long-chain lengths may be retained predominately in an upstream portion of the packed bed and/or at least one of the plurality of substances comprising short-chain lengths may migrate to a downstream portion. In these embodiments, the housing can also be configured to allow access to discrete vertical segments of the bed for sampling.

In some embodiments, sampling from the top and/or bottom of the packed bed can indicate a higher plurality of short-chain length substances in the downstream portion relative to the upstream portion. In some embodiments, the plurality of substances may comprise per- and/or polyfluoroalkyl substances (PFAS), perfluorooctanesulfonic acid (PFOS), perfluorobutanoic acid (PFBA), and/or perfluorobutane sulfonic acid (PFBS)).

In some embodiments, the media mix of BIPGEM may comprise about 80% sand, about 5% biochar, about 5% clay, about 5% perlite, and/or about 5% ZVI by volume. In these other embodiments, at least one iron filings of the BIPGEM may be powdered zero valent iron, which may be more advantageous than iron oxides in effectively removing PFAS and/or exhibit enhanced stability in sorption processes.

When employed in conjunction, in some embodiments, biochar and/or perlite may be configured to synergistically maximize adsorption for long-chain PFAS (e.g., PFOA and PFOS), leveraging both hydrophobicity and/or electrostatic interactions on the media surface. Biochar as a component of BIPGEM, may also demonstrate improved stability in sorption processes by favoring the point of zero charge. In these other embodiments, BIPGEM may also possess high surface area (about 1.35 m²·g⁻¹) which may be attributed to the presence of biochar and/or perlite. Additionally, in these other embodiments, the BIPGEM may comprise a high porosity (about 30%) and/or hydraulic conductivity (about 1.2×10⁻⁴ m·s⁻¹), supporting the proposition that higher hydraulic conductivity corresponds to an increased Darcy flux. This, in turn, leads to faster liquid penetration through the porous media.

In some embodiments, BIPGEM may comprise a green sorption media mix formulated based on recycled materials (e.g., iron filings and biochar) which may be blended with natural materials (e.g., sand, clay, and perlite), such that the BIPGEM may be used for both ex-situ and/or in-situ water treatment applications. In these other embodiments, the BIPGEM may not only be used in water and/or wastewater treatment processes but also applied as a fit-for-purpose treatment in most type of landscapes as well as low impact development for green building or green infrastructure with simple operation. As such, for in situ treatment, BIPGEM may be used as a pretreatment for subsequent expensive treatment process such as Anion Exchange resin (AER), membrane, and/or nanofiltration, offering an integrated treatment train for improved process reliability and/or cost effectiveness. In this manner, BIPGEM may be dedicated to removing most of the long-chain PFAS and/or a portion of the short-chain PFAS, while the subsequent process (AER, nanofiltration, and/or membrane) would remove any remaining PFAS. Overall, in these other embodiments, BIPGEM may remediate PFAS contaminated environmental media in a scalable, adaptable, sustainable, flexible, and/or cost-effective way.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a line graph depicting PZC for BIPGEM and its five media components individually before and after treatment, according to an embodiment of the present disclosure.

FIGS. 2A-2B are graphs depicting a XRD spectra of raw and used BIPGEM, according to an embodiment of the present disclosure. FIG. 2A depicts the XRD spectra of raw and used BIPGEM in counts per second; and FIG. 2B depicts the XRD spectra of raw and used BIPGEM in intensity (a.u.).

FIGS. 3A-3E are line plots depicting a XPS spectra for raw BIPGEM, according to an embodiment of the present disclosure. FIG. 3A depicts the XPS spectra of Si2p for raw BIPGEM; FIG. 3B depicts the XPS spectra of Ols for raw BIPGEM; FIG. 3C depicts the XPS spectra of C1s for raw BIPGEM; FIG. 3D depicts the XPS spectra of A12p for raw BIPGEM; and FIG. 3E depicts the XPS spectra of Fe2p for raw BIPGEM.

FIGS. 4A-4E are line plots depicting a XPS survey analysis for each component for BIPGEM, according to an embodiment of the present disclosure. FIG. 4A depicts the XPS survey analysis for a biochar component for BIPGEM; FIG. 4B depicts the XPS survey analysis for a clay component for BIPGEM; FIG. 4C depicts the XPS survey analysis for a perlite component for BIPGEM; FIG. 4D depicts the XPS survey analysis for a sand component for BIPGEM; and FIG. 4E depicts the XPS survey analysis for a ZVI component for BIPGEM.

FIGS. 5A-5H are FE-SEM images of raw and used components for BIPGEM, according to an embodiment of the present disclosure. FIG. 5A depicts a raw biochar component for BIPGEM; FIG. 5B depicts a used biochar component for BIPGEM; FIG. 5C depicts a raw perlite component for BIPGEM; FIG. 5D depicts a used perlite component for BIPGEM; FIG. 5E depicts a raw ZVI component for BIPGEM; FIG. 5F depicts a used ZVI component for BIPGEM; FIG. 5G depicts a raw sand component for BIPGEM; and FIG. 5H depicts a used sand component for BIPGEM.

FIGS. 6A-6E are FE-SEM survey analysis for each component for raw BIPGEM, according to an embodiment of the present disclosure. FIG. 6A depicts a perlite component for the raw BIPGEM; FIG. 6B depicts a biochar component for the raw BIPGEM; FIG. 6C depicts a clay component for the raw BIPGEM; FIG. 6D depicts a ZVI component for the raw BIPGEM; and FIG. 6E depicts a sand component for the raw BIPGEM.

FIGS. 7A-7B are bar graphs depicting removal percentages of each media component for BIPGEM, according to an embodiment of the present disclosure. FIG. 7A depicts removal percentage of PFAS by each media component in solutions spiked with FPAS mixture; and FIG. 7B depicts a removal percentage of PFBA only by biochar, perlite, and ZVI.

FIGS. 8A-8C are line plots depicting comparison of long- and short-chain PFAS and GEnX removal percentage by adsorption medias, according to an embodiment of the present disclosure. FIG. 8A depicts a comparison of long- and short-chain PFAS and GenX removal percentage of CPS; FIG. 8B depicts a comparison of long- and short-chain PFAS and GenX removal percentage of ZIPGEM; and FIG. 8C depicts a comparison of long- and short-chain PFAS and GenX removal percentage of BIPGEM.

FIG. 9 is a line plot depicting breakthrough curves of long-chain and short-chain PFAS and GenX for BIPGEM, according to an embodiment of the present disclosure.

FIG. 10 is a graphical illustration depicting interactions of PFAS compounds with BIPGEM constituents in water and related PFAS removal mechanisms, according to an embodiment of the present disclosure.

FIGS. 11A-11E are graphical illustrations depicting simulations for each component of BIPGEM to realize removal mechanisms, according to an embodiment of the present disclosure. FIG. 11A depicts simulations for a sand component of BIPGEM to realize removal mechanisms; FIG. 11B depicts simulations for a perlite component of BIPGEM to realize removal mechanisms; FIG. 11C depicts simulations for a ZVI component of BIPGEM to realize removal mechanisms; FIG. 11D depicts simulations for a clay component of BIPGEM to realize removal mechanisms; and FIG. 11E depicts simulations for a biochar component of BIPGEM to realize removal mechanisms.

FIGS. 12A-12C are line plots depicting dynamic adsorption models for PFOA, according to an embodiment of the present disclosure. FIG. 12A depicts the linearized Thosmas model of BIPGEM on PFOA; FIG. 12B depicts the linearized Yoon-Nelson model of BIPGEM on PFOA; and FIG. 12C depicts the linearized MDR model of BIPGEM on PFOA.

FIGS. 13A-13C are line plots depicting dynamic adsorption models for PFOS, according to an embodiment of the present disclosure. FIG. 13A depicts the linearized Thosmas model of BIPGEM on PFOS; FIG. 13B depicts the linearized Yoon-Nelson model of BIPGEM on PFOS; and FIG. 13C depicts the linearized MDR model of BIPGEM on PFOS.

FIGS. 14A-14C are line plots depicting dynamic adsorption models for PFBS, according to an embodiment of the present disclosure. FIG. 14A depicts the linearized Thosmas model of BIPGEM on PFBS; FIG. 14B depicts the linearized Yoon-Nelson model of BIPGEM on PFBS; and FIG. 14C depicts the linearized MDR model of BIPGEM on PFBS.

FIGS. 15A-15C are line plots depicting dynamic adsorption models for GenX, according to an embodiment of the present disclosure. FIG. 15A depicts the linearized Thosmas model of BIPGEM on GenX; FIG. 15B depicts the linearized Yoon-Nelson model of BIPGEM on GenX; and FIG. 15C depicts the linearized MDR model of BIPGEM on GenX.

FIGS. 16A-16C are line plots depicting a residual analysis of Hypothesis 1 disclosed within TABLE 6, provided below, according to an embodiment of the present disclosure. FIG. 16A depicts a QQ plot analysis of Hypotheses 1; FIG. 16B depicts a residual plot analysis of Hypotheses 1; and FIG. 16C depicts a Homoscedasticity plot analysis of Hypotheses 1.

FIG. 17 is a bar graph depicting Dynamic long- and short-chain PFAS and GenX adsorptive removal percentage of BIPGEM, according to an embodiment of the present disclosure.

FIG. 18 is a series of three-dimensional response surface plots of combined pH-TOC (mg·L⁻¹) effects on removal efficiency of target PFAS, according to an embodiment of the present disclosure.

FIGS. 19A-19C are line plots depicting a residual analysis of Hypotheses 2 disclosed within TABLE 6, provided below, according to an embodiment of the present disclosure. FIG. 19A depicts a QQ plot analysis of Hypotheses 2; FIG. 19B depicts a residual plot analysis of Hypotheses 2; and FIG. 19C depicts a Homoscedasticity plot analysis of Hypotheses 2.

FIG. 20 is a correlation heatmap depicting a correlation between the removal percentage of PFAS and water quality parameters at the significance level of 0.05 (p≤0.05), according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

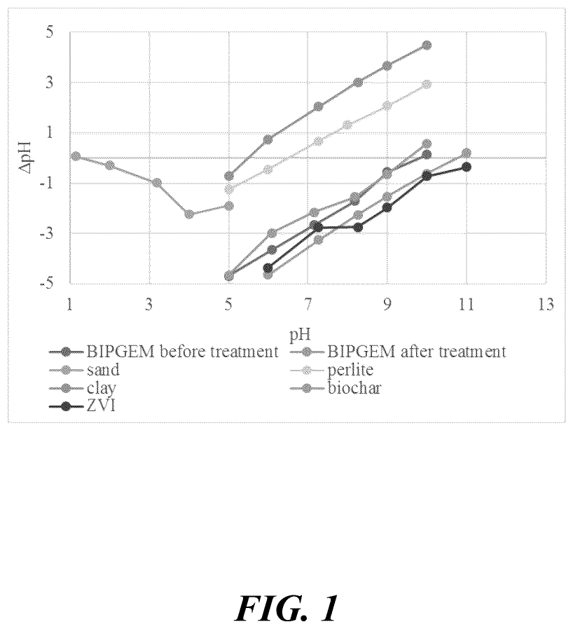

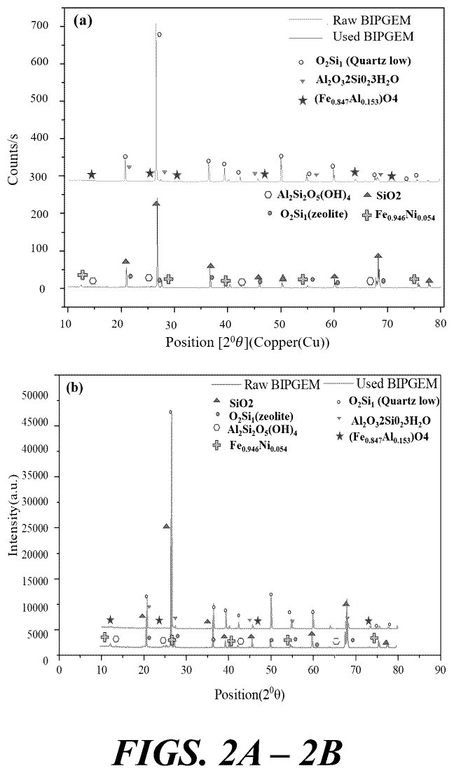

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose, such as performing targeted removal of per- and/or polyfluoroalkyl substances (PFAS) (e.g., Perfluorooctanoic acid (PFOA), perfluorooctanesulfonic acid (PFOS), perfluorobutanoic acid (PFBA), and/or perfluorobutane sulfonic acid (PFBS)) in water matrices (e.g., surface water and/or groundwater)). As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

Per- and/or Polyfluoroalkyl Substance Adsorbent

The present disclosure pertains to an adsorbent and method for performing targeted removal of per- and/or polyfluoroalkyl substances (hereinafter “PFAS”) (e.g., Perfluorooctanoic acid (hereinafter “PFOA”), perfluorooctanesulfonic acid (hereinafter “PFOS”), perfluorobutanoic acid (hereinafter “PFBA”), and/or perfluorobutane sulfonic acid (hereinafter “PFBS”)) in water matrices (e.g., surface water and/or groundwater). In embodiments, the adsorbent may comprise of at least one portion biochar-based iron and/or may be integrated with at least one portion of perlite, such that the biochar-based iron and/or perlite-integrated green environmental media (hereinafter “BIPGEM”) may be configured to effectively remove at least one PFAS from at least one water matrix. In these embodiments, BIPGEM may comprise a high surface area, high point of zero charge (hereinafter “PZC”), and/or better binding capacity, which may be favorable for PFAS adsorption.

In embodiments, the BIPGEM may be a composition comprising a mixture of sand, biochar, clay, perlite, and/or ZVI. As such, in these embodiments, the sand may be present within the BIPGEM in an amount comprising a range of about 60% by volume to about 90% by volume, encompassing every value in between; the biochar may be present within the BIPGEM in an amount comprising a range of about 1% by volume to about 10% by volume, encompassing every value in between; the clay may be present within the BIPGEM in an amount comprising a range of about 1% by volume to about 10% by volume, encompassing every value in between; the perlite may be present within the BIPGEM in an amount comprising a range of about 1% by volume to about 10% by volume, encompassing every value in between; and/or the ZVI may be present within the BIPGEM in an amount comprising a range of about 1% by volume to about 10% by volume, encompassing every value in between. For example, in some embodiments, the BIPGEM may comprise a mixture having about 80% by volume of sand, about 5% by volume of biochar, about 5% by volume of clay, about 5% by volume of perlite, and/or about 5% by volume of ZVI.

Additionally, In embodiments, the density of the BIPGEM may comprise a range of about 1.00 g·cm⁻³ to about 3.50 g·cm⁻³, encompassing every value in between. For example, in some embodiments, the density of the BIPGEM may comprise about 2.59 g·cm⁻³. Moreover, in embodiments, the surface area of the BIPGEM may comprise a range of about 1.00 m²·g⁻¹ to about 2.50 m²·g⁻¹, encompassing every value in between. For example, in some embodiments the surface area of BIPGEM may be about 1.35 m²·g⁻¹. As such, in embodiments, the high BET surface area of the BIPGEM may be due to the amount of biochar and/or perlite within the BIPGEM. Furthermore, in embodiments, the BIPGEM may comprise a porosity of about 10% to about 50%, encompassing every value in between. For example, in some embodiments, the BIPGEM may comprise a porosity of about 30%. In addition, in embodiments, the BIPGEM may comprise a hydraulic conductivity of about 0.5×10⁻⁴ m·s⁻¹ to about 2.5×10⁻⁴ m·s⁻¹, encompassing every value in between. For example, in some embodiments, the BIPGEM may comprise a hydraulic conductivity of about 1.2×10⁻⁴ m·s⁻¹.

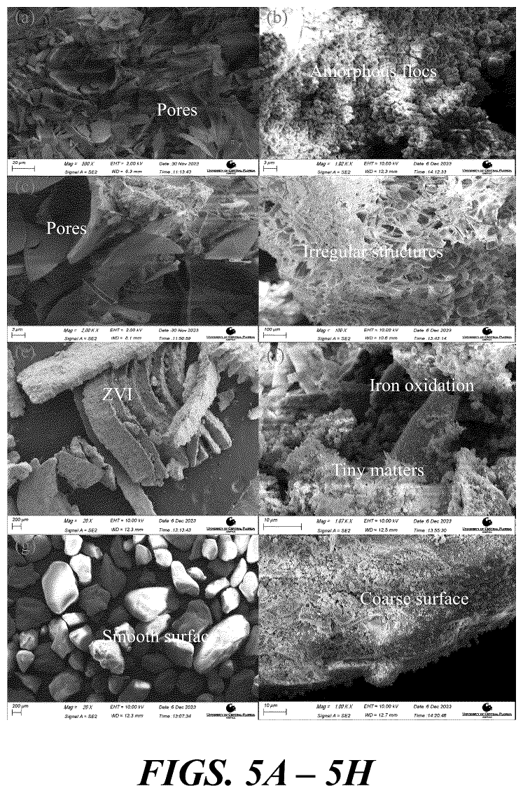

As shown in FIG. 5, in embodiments, the BIPGEM may be configured to remove at least about 95% of at least one PFOS from at least one water matrix (e.g., surface water and/or groundwater) within at most about 36 hours. For PFOA, BIPGEM may be configured to remove at least about 40% from the at least one water matrix within at most about 40 hours.

The removal efficiency of long-chain PFAS by BIPGEM was essentially about twice as much as that of short-chain PFAS over the 44-h duration. However, initially, only a difference of about 30% between the removal percentages of long-chain and short-chain PFAS was observed, which was quite reasonable since the column was yet to reach equilibration, leaving adequate sites for short-chain PFAS adsorption. Long-chain PFAS removal efficiency was sustained at a level exceeding 80% during the initial 21 h. Specifically, within the first 6 h, the removal percentage remained consistently above 85%. Subsequently, up until the 44th h, the removal percentage of long-chain PFAS remained above 50%. For short-chain PFAS, a decline was observed from the 4th hour onwards, with the removal percentage ranging between 20% to 40%. Notably, this condition persisted for approximately 40 h, until reaching the 44th h, at which point the removal percentage of short-chain PFAS dropped below 20%.

In embodiments, the two key mechanisms of PFAS adsorption by BIPGMEN may be hydrophobic and/or electrostatic interactions. As such, in these embodiments, BIPGEM may be configured to remove the predominantly hydrophobic PFAS, especially PFOS and PFOA through hydrophobic interactions. In this manner, the long-chain PFAS may be removed by the BIPGEM through hydrophobic interactions. Moreover, in these embodiments, in addition to the hydrophobic and electrostatic interactions, BIPGEM may be configured to implement a ligand exchange to serve as one of the mechanisms for PFAS removal. Accordingly, in these embodiments, the process may involve the formation of an inner-sphere complex, such that at least one organic functional group (e.g., a hydroxyl and/or carboxylate) may displace at least one inorganic hydroxyl and/or at least one water molecule bound to a metal ion of the BIPGEM, including but not limited to Fe and/or Al, at least one portion of a surface of at least one soil mineral. In addition, hydroxyl groups (e.g., —OH) may also be formed on at least one portion of a surface of metal of the BIPGEM under certain matrix conditions. The interaction potential and/or exchangeability of —OH groups may provide metal surface reactivity for PFAS adsorption for the BIPGEM. In this manner, in these embodiments, the at least one hydroxyl group formed on the metal surfaces (e.g., Fe and/or Al) of the BIPGEM may be replaced by PFAS via the ligand exchange. The ligand exchange may occur during the adsorption of PFOA onto iron oxide. Accordingly, by dissociating the water molecule from the surface metal center, the protonated hydroxyl groups (Fe³⁺—OH) may then be replaced by PFAS anions. Additionally, in these embodiments, ZVI of the BIPGEM may be oxidized to Fe²⁺ and further to Fe³⁺.

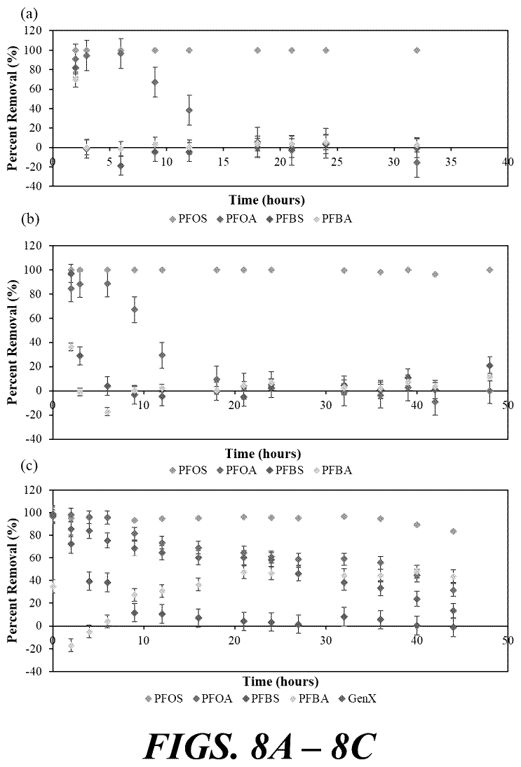

In embodiments, the porous structure of the at least one portion of perlite of the BIPGEM may allow at least one of a plurality of PFAS species to penetrate different layers of the BIPGEM, As shown in FIG. 8B, in these embodiments, short-chain PFAS may enter the inner layer of the BIPGEM, long-chain PFAS may enter the middle layer of the BIPGEM, and/or the GenX may remain at the third layer of the BIPGEM, such that the GenX chemicals may likely interact with at least one of a plurality of long-chain PFAS which have entered within the middle layer of the BIPGEM. In addition, in these embodiments, ZVI of the BIPGEM may also contribute to the removal of PFBS, PFBA, and/or PFOA through electrostatic interactions,

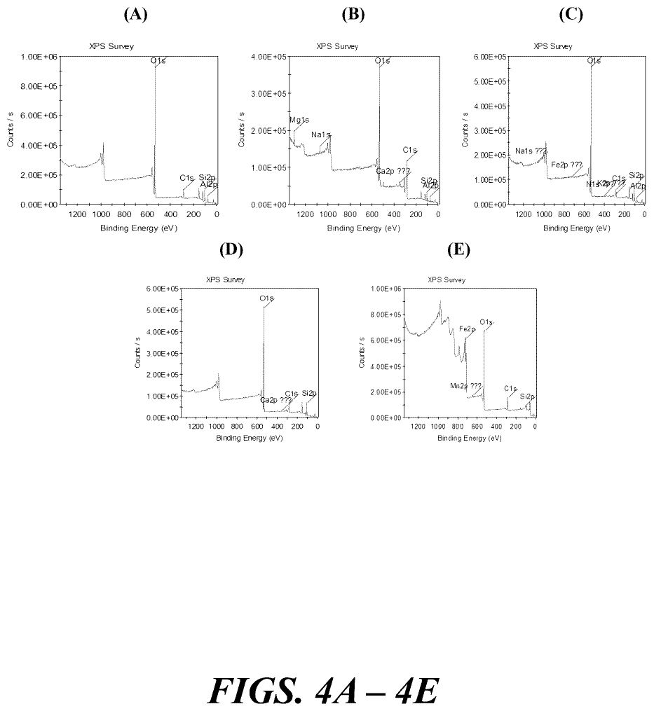

Moreover, clay and/or biochar may also be critical to influencing PFAS removal. As shown in FIG. 8D and FIG. 8E, in embodiments, except for PFBA, clay and/or biochar may be configured to remove the other PFAS, consistent with a Cₜ/C₀ value comprising a range of about 0.1 to about 0.9, encompassing every value in between. For example, in some embodiments, the Cₜ/C₀ value may be 0.5 for PFBA after 22 h. This aligns with the performance of biochar and/or perlite in removing only PFBA in the adsorption test while spiking a mixture of PFAS, as shown in FIG. 4E, and/or PFBA, as shown in FIG. 4B in the influent. Additionally, as shown in FIG. 8D and/or FIG. 8E, in these embodiments, a competitive adsorption between long-chain PFAS and short-chain PFAS may occur within the BIPGEM, particularly PFBA and/or long-chain PFAS.

As such, in embodiments, during adsorption, the biochar of the BIPGEM may exhibit at least about a 99% removal rate for long-chain PFAS. In addition, the biochar of the BIPGEM may comprise at least about a 75% removal rate of PFBA when the influent was only spiked with PFBA. This underscores biochar's potential for adsorbing both long-chain and short-chain PFAS. Nevertheless, it is crucial to consider influent conditions to achieve high removal rates.

Typically, in embodiments, the biochar surfaces of the BIPGEM may be hydrophobic, such that the biochar may facilitate the adsorption of hydrophobic PFAS (e.g., C—C bonds) via hydrophobic interactions. In this manner, the PZC for the biochar may be at a pH of about 10.7, as shown in FIG. 1, and/or given the at least one water matrix (e.g., surface water and/or groundwater) pH comprising a range of about 7.50 to about 9.50, encompassing every value in between, in these embodiments, the biochar of the BIPGEM may also comprise and/or exhibit a positive charge, suggesting its potential to electrostatically absorb anionic PFAS. Additionally, the distribution coefficient (K_{d}) values for PFOA and/or PFOS may comprise about 14.40 and/or about 22.25 for sand of the BIPGEM, respectively, whereas for the biochar of the BIPGEM, the K_{d} values for PFOA and/or PFOS may comprise about 12,034.23 and/or about 9,278.58, respectively. This indicates that the inclusion of the biochar in the BIPGEM may reduce the mobility of PFOA and/or PFOS in the water-solid system (i.e., water matrices). Furthermore, in these embodiments, the ability of the biochar of the BIPGEM to remove PFOA may also be attributed to the presence of bivalent and monovalent cations (e.g., P, Ca, Mg) in the at least one water matrices, which may comprise a higher potential to form complex salts as these cations may be adsorbed onto negatively charged media surfaces such perlite, clay, and/or ZVI. Moreover, the ability of the biochar of the BIPGEM to remove PFOA may also be attributed to the presence of bivalent and monovalent cations (e.g., P, Ca, Mg) in the at least one water matrices (e.g., canal water), which may comprise a higher potential to form complex salts as these cations can be adsorbed onto negatively charged media surfaces such as perlite, clay, and/or ZVI.

As such, in embodiments, BIPGEM may be configured to optimize the removal efficiency and/or removal mechanisms of PFOA, PFOS, PFBA, PFBS, and/or GenX from at least one water matrices (e.g., surface water and/or groundwater). In these embodiments, the BIPGEM may be configured to remove long-chain PFAS by each component of the BIPGEM through hydrophobic and/or electrostatic interactions. Owing to the weak electrostatic interaction exhibited by short-chain PFAS and BIPGEM, their removal percentage may be comparatively lower to the long-chain PFAS, however, the BIPGEM may still effectively remove part of the short-chain PFAS. Conversely, the removal of short-chain PFAS through adsorption was challenging, likely because they do not readily bind to particles and remain soluble in water. However, the adsorption of long-chain PFAS had an evident influence on the adsorption of short-chain PFAS, with the latter being unable to outcompete the former for adsorption sites, attributable to the higher sorption coefficients of long-chain PFAS. In the fixed-bed column study, BIPGEM exhibited better performance in removing long-chain PFAS from C-23 canal water when compared to that of short-chain PFAS. This enhanced efficiency in removing long-chain PFAS could be attributed to the extensive surface size of BIPGEM and its positive surface charge (observed at pH levels below PZC that was 11.5).

In the newly developed specialty adsorbent (BIPGEM), biochar played a significant role in achieving complete removal of PFOA and attaining fair removal percentages for short-chain PFAS. However, the contribution of biochar, like the other constituents, on PFAS removal was dependent on competitive adsorption, and hydrophobic and electrostatic interactions driven by various water quality parameters (e.g., cations, natural organic matter (NOM), pH). It was imperative to acknowledge that the spent filtration media would necessitate final disposal, as such sorption processes may not entail the destruction of PFAS. Finally, future studies should investigate the intricate interplay between nutrients and the mechanisms governing PFAS adsorption and removal, in order to gain a comprehensive understanding of the competitive and synergistic effects at play in surface water matrices.

The following example(s) is (are) provided for the purpose of exemplification and is (are) not intended to be limiting.

### EXAMPLES

### Example #1

Effect of Biochar in BIPGEM on Enhanced PFAS Removal from Surface Water

### Water Sampling and PFAS Analysis

Water samples were collected from the C-23 Canal in June 2023. The sampling location was strategically chosen because of its proximity to the St. Lucie River, which is a significant tributary of the IRL. TABLE 2, provided below, lists the physio-chemical properties of the PFAS tested in this study. The background average PFAS concentrations in C-23 are also presented TABLE 3, provided below.

PFAS analyses in water samples were carried out using in-house LC-MS-MS following the EPA method 533 [48]. An aliquot of samples (250 mL) was collected and extracted via solid phase extraction. The extracted analytes were eluted with methanol and 5% ammonium hydroxide in methanol solvent. The eluted samples were dried with N₂ and reconstituted to 1 ml with 96:4 (v/v) methanol:water. The samples were then injected into a C18 LC column, where the PFAS were separated through a methanol and 10 mM ammonium acetate gradient. The separated compounds were detected by mass spectroscopy at their respective retention time. The detection limits for PFOS, PFOA, Gen-X, PFBS and PFBA were 0.8, 1.2, 2, 0.4, and 1.5 ng·L⁻¹, respectively.

TABLE 2

| | | | | Molecular | | |
|---|---|---|---|---|---|---|
| | | | | Weight | | |
| | | | Chemical | (g · | | Log |
| | PFAS | CAS# | Formula | mol⁻¹) | pKₐ | D |
| Long- | Perfluorooctanoic acid | 335-67-1 | C₇F₁₅COOH | 414.07 | −0.20 | 1.58 |
| chain | (PFOA) | | | | | |
| | Perfluorooctanesulfonic | 1,763-23-1 | C₈F₁₇SO₃H | 500.13 | 0.14 | 3.05 |
| | acid (PFOS) | | | | | |
| Short- | Perfluorobutanoic acid | 375-22-4 | C₃F₇COOH | 214.04 | 0.40 | −1.22 |
| chain | (PFBA) | | | | | |
| | Perfluorobutanesulfonic | 375-73-5 | C₄F₉SO₃H | 300.10 | 0/14 | 0.25 |
| | acid (PFBS) | | | | | |

| | | | | | |
|---|---|---|---|---|---|
| hexafluoropropylene oxide dimer | 13,252-13-6 | C₆HF₁₁O₃ | 330.05 | 2.84 | 0.47 |
| acid (HFPO-DA or GenX) | | | | | |

TABLE 3

| | Climate | PFOA | PFBS | PFOS | PFBA | HFPODA |
|---|---|---|---|---|---|---|
| Sampling Date | Season | (ng/L) | (ng/L) | (ng/L) | (ng/L) | (ng/L) |
| Apr. 11, 2023 | Dry | 22 | 18 | 15 | 14 | ND |
| Apr. 25, 2023 | Dry | 15 | 16 | 11 | 12 | ND |
| May 9, 2023 | Wet | 18 | 18 | 18 | 13 | ND |
| May 23, 2023 | Wet | 20 | 20 | 15 | 14 | ND |
| Jun. 6, 2023 | Wet | 15 | 21 | 10 | 12 | ND |
| Jun. 20, 2023 | Wet | 13 | 18 | 10 | 11 | ND |
| Jul. 3, 2023 | Wet | 6.7 | 5.7 | 7 | 6.1 | ND |

| | | | | | |
|---|---|---|---|---|---|
| average | 15.67 | 16.67 | 12.29 | 11.73 | ND |

### Media Characterization

BIPGEM media is a blend of sand (80%), biochar (5%), clay (5%), perlite (5%), and ZVI (5%) by volume. The ZVI of the media mix was obtained from Connelly-GPM, Inc. (Chicago, USA). The perlite (99.44%) was procured from Miracle-Gro®. Biochar sourced from both softwood and tree trimmings was procured from Plantonix Inc. (Oregon, USA). Paving sand was obtained from Sunniland (Orlando, Florida). The physical characteristics, including BET surface area and density, were determined at the EMSL Analytical, Inc. laboratories. Density and BET surface area were measured following ASTM D854 and ASTM B922 methods. The saturated hydraulic conductivity was measured using the constant head permeability test at the University of Central Florida (UCF) Geotechnical Laboratories. The point of zero charges (PZC) for BIPGEM and its individual components were measured following the salt addition method [44], which determines the pH when the surface of the adsorbent is at ionic equilibrium, and the net charge of the surface of the particle is equal to zero. The protocol followed to determine zeta potential is presented in detail by Ordonez et al. [45].

Chemical characterization of BIPGEM was conducted to delineate the effects of BIPGEM constituents on PFAS removal mechanisms. X-ray fluorescence (XRF), X-ray diffraction (XRD) analysis, X-ray photoelectron spectroscopy (XPS), and field emission scanning electron microscopy (FE-SEM) were conducted at the materials characterization facility of the Advanced Materials Processing and Analysis Center at UCF. XRF elemental composition was performed using PANalytical Epsilion. XRD spectroscopy was performed using a PANalytical Empyrean XRD instrument. FE-SEM spectra were obtained using the Zeiss ULTRA-55 electron microscope, operated at an accelerating voltage of 10 kV. XPS spectra were obtained using Escalab 250Xi.

### Experimental Protocol

First, batch adsorption experiments were performed for PFOS, PFOA, PFBA, PFBS, and GenX to determine the sorption coefficients (Kd) for each component (sand, clay, biochar, ZVI, and perlite) of BIPGEM. Following the adsorption tests, fixed-bed column studies were conducted using a triplicate set of columns filled with BIPGEM to determine the removal percentages and breakthrough under dynamic filtration condition. Glass Erlenmeyer flasks were prepared by placing 1 g of each component in 100 ml of DI water spiked with PFAS at an initial total concentration of 250 ng·mL⁻¹ (50 ng·mL⁻¹ of each of PFAS) in triplicate. The flasks were then shaken for 24 h on an orbital shaker at 150 rpms at room temperature. Samples were collected after 24 h, filtered with 0.45 μm pore size membrane filter, extracted using solid phase extraction and analyzed for PFOS, PFOA, PFBS, PFBA, and GenX. A separate batch adsorption study was conducted for biochar, perlite, and ZVI with PFBA (50 ng·mL⁻¹) only to test if adsorption of long-chain PFAS affects that of the short-chain PFAS.

### Dynamic Adsorption Models

Data obtained from the column studies were analyzed using selected dynamic adsorption models, as provided in TABLE 4 below, to determine PFAS breakthrough during filtration, facilitating the determination of the suitability of the media for field-scale application. These models are commonly applied to understand dynamic adsorption mechanisms in filtration media for real-world applications. The Thomas model has been used to fit the adsorption breakthrough curves for PFCAs and PFSAs and, specifically for PFOS and PFOA by Ordonez et al. [37]. The Yoon-Nelson and modified dose-response (MDR) models were used as well for dynamic adsorption analysis of PFOA and PFOS [37].

TABLE 4

| | Equation | Reference |
|---|---|---|
| Thomas | $ln ( \frac{{c}_{0}}{{c}_{t}} - 1 ) = \frac{{K}_{TH} {q}_{0} m}{Q} - {K}_{TH} {c}_{0} t$ | [46] |
| Yoon-Nelson | $ln ( \frac{{C}_{0}}{{C}_{t}} - 1 ) = {K}_{YN} τ - {K}_{YN} t$ | [47] |
| MDR | $ln ( \frac{{c}_{t}}{{c}_{0} - {c}_{t}} ) = {a}_{MDR} ln ( {c}_{0} Q t ) - {a}_{MDR} ln ( {q}_{0} m )$ | [48] |

*Parameter explanation:
C₀ is the concentration of each PFAS species at the inlet of the column (ng · L⁻¹).
Cₜ is the concentration of each PFAS species at the outlet of the column (ng · L⁻¹).
K_{TH} is the Thomas rate constant (in L · min⁻¹ · ng⁻¹).
m is the mass (in g), Q is the influent flow rate (in L · min⁻¹).
t is time (in min).
q₀ is the maximum adsorption capacity of the media (in ng · g⁻¹).
K_{YN} is the Yoon-Nelson rate constant (in min⁻¹).
τ is time required for 50% of adsorbate breakthrough (in min).
a_{MDR} is the MDR rate constant (dimensionless)

### PFAS Breakthrough in Fixed-Bed Columns

Breakthrough curves are generally characterized by four key points including the breakpoint (t_{b}), the mass transfer point (t_{0.5}), the operating point (t_{0.9}), and the total exhaustion point (tₑ) [49]. At the breakpoint, the ratio between Cₜ and C₀ is equal to 0.05 (Cₜ/C₀=0.05). The point at which the ratio of Cₜ and C₀ is equal to 0.5 (Cₜ/C₀=0.5) is known as the mass transfer zone and at this point, the media reaches half of its adsorption capacity. The exhaustion point is the point when the value of Cₜ/C₀ is equal to 1 and the media reaches its equilibrium capacity of adsorption. However, the operating limit of the column is defined by 90% of media adsorption capacity (i.e., the point at the breakthrough curve when the Cₜ/C₀ is equal to 0.9).

For PFOA, t_{b}, t_{0.5}, t_{0.9}, and the were 7, 20, 40, and 42 h, respectively, whereas for PFOS, t_{b} was 30 h, and t_{0.5} was longer than 45 h, and t_{0.9}, and the both were much longer than 45 h. Hence, PFOS took much longer to reach the exhaustion point than PFOA. For PFBS, t_{b}, t_{0.5}, t_{0.9}, and the were <1, 3, 8, and 9 h, respectively, whereas for GenX, t_{b}, t_{0.5}, t_{0.9}, and the were 1.5, 9, 40, and 42 h, respectively, as shown in TABLE 5, provided below. Even though PFBA's breakthrough curve was not typical, it showed early suppression but continued to be adsorbed past 44 h.

TABLE 5

| | PFOS | PFOA | PFBS | PFBA | GenX |
|---|---|---|---|---|---|
| t_{b} (hours) | 30 | 7 | <1 | <1 | 1.5 |
| t_{0.5} (hours) | >45 | 20 | 3 | — | 9 |
| t_{0.9} (hours) | >>45 | 40 | 8 | — | 40 |
| tₑ (hours) | >>45 | 42 | 9 | — | 42 |

### Statistical Analysis

Response Surface methodology (RSM)

Response surface methodology (RSM) is a widely used empirical model that involves the aggregation of tools for experimental design and data analysis, enhancing the investigation of design factors on one or multiple responses [50]. The application of a second-order model is commonly practiced in response surface techniques (Eq. 1).

$${y}_{ij} = {β}_{0} + {\sum }_{i = 1}^{k} {β}_{i} {X}_{i} + {\sum }_{i = 1}^{k} {β}_{ii} {X}_{i}^{2} + {\sum }_{i = 1 , i < j}^{k} {β}_{ij} {X}_{i} {X}_{j} + {ϵ}_{ij} \qquad ( 1 )$$

Here, yᵢⱼ represents a dependent or measured response, Xᵢ and Xⱼ, i=1 . . . , k−1, (j=2 . . . k) are the different independent variables, k represents the number of independent variables, β₀ represents the intercept, βᵢ represents the linear coefficient, βᵢⱼ represents the quadratic coefficient, βᵢⱼ represents the cross-product coefficient, and/or ∈ᵢⱼ represents a random error with mean zero and variance σ².

### Analysis of Variance (ANOVA)

One way analysis of variance (hereinafter “ANOVA”) was used to determine any statistically significant differences in 1) the efficiencies of adsorption of PFBA in the presence and absence of other 4 PFAS in the batch experiment; 2) the removal efficiencies between the long- and short-chain PFAS and GenX in the fixed column study. The null hypothesis (H₀) and the alternative hypothesis (Hₐ) are given by Eqs. (2) and (3), respectively. The null hypothesis was rejected when the p value was less than a (0.05) at 95% confidence interval.

$${H}_{0} : {μ}_{1} = {μ}_{2} = … {μ}_{k} \qquad ( 2 )$$

$${H}_{a} : means were not all equal or at least one mean was different \qquad ( 3 )$$

$${SS}_{between} = {\sum }_{i}^{k} {{n}_{i} ( {X}_{i} - X )}^{2} \qquad ( 4 )$$

$${SS}_{within} = {\sum }_{i}^{k} ( {n}_{i} - 1 ) {{S}_{i}}^{2} \qquad ( 5 )$$

Where μ represents the average of each independent group; SS_{between} represents the sum of squares between groups; SS_{within} represents the sum of squares within groups;

$$F ( = \frac{{MS}_{within}}{{MS}_{between}} )$$

represents the ANOVA coefficient;

$${MS}_{between} ( = \frac{{SS}_{between}}{K - 1} )$$

represents the mean sum of squares between groups;

$${MS}_{within} ( = \frac{{SS}_{within}}{n - k} )$$

represents the mean sum of squares within groups; k represents the number of groups, n represents the sample size; Xᵢ represents the average of group I; and/or X represents the overall group average. TABLE 6, provided below, lists the proposed hypotheses.

TABLE 6

| | Aspects | H_{O} | Hₐ |
|---|---|---|---|
| Hypothesis 1 | Removal efficiencies of PFBA with and without other 4 PFAS | − | + |
| | in the adsorption test | | |
| Hypothesis 2 | Removal efficiencies of long-chain PFAS, short-chain PFAS, | − | + |
| | and GenX by BIPGEM in a fixed column study | | |

### Results

### Physio-Chemical Properties of BIPGEM Media

The PZC of BIPGEM before and after the fixed-bed column study, and those of biochar, perlite, clay, ZVI, and sand were determined independently at pHs of 9.5, 9.8, 10.7, 6.5, 5.5, 11.5, and 1.2, respectively, as shown in FIG. 1. The density of BIPGEM is 2.59 g. cm⁻³, and the high BET surface area of the media (1.35 m²·g⁻¹) can be attributed to biochar and perlite. Moreover, BIPGEM has high porosity (30%) and hydraulic conductivity (1.2×10⁻⁴ m·s⁻¹) [38], which could support the postulation that increased hydraulic conductivity results in a greater Darcian flow, accelerating the liquid's penetration through porous materials [51].

According to the XRF data, as shown in TABLE 7, provided below, in the raw BIPGEM material, silicon, iron, and aluminum were the three most dominant elements with 70.73%, 11.83%, and 9.98% of the media composition, respectively. Silicon, iron, and aluminum ranked top three in used BIPGEM as well with iron and aluminum compositions increasing by approximately 6% and 2%, respectively, when compared to those in the raw media mix. The proportion of silicon decreased from 70.73% to 61.17%. Additionally, the proportion of metal oxides, Al₂O₃, and Fe₂O₃ increased significantly, from 12.24% to 14.89% and 1.31% to 9.16%, respectively. The average concentration of dissolved iron in the effluents was 0.48 mg·L⁻¹ at 2 hours and decreased to 0.27 mg·L⁻¹ at 16 hours. Subsequently, from 32 hours until the end, no dissolved iron was detected in the effluents. A similar decreasing trend was observed for the average concentration of dissolved aluminum in the effluents. These substantial changes indicate the efficacy of the BIPGEM column in treating polluted water.

TABLE 7

| Element | Raw (%) | Used (%) | Oxides | Raw (%) | Used (%) |
|---|---|---|---|---|---|
| Al | 9.98 | 12.27 | Al₂O₃ | 12.24 | 14.89 |
| Si | 70.73 | 61.17 | SiO₂ | 77.08 | 69.79 |
| P | 1.48 | 2.13 | P₂O₅ | 2.37 | 2.18 |
| CI | 0.35 | 1.63 | SO₃ | 0.34 | 0.00 |
| K | 0.77 | 2.76 | Cl | 0.93 | 0.72 |
| Ca | 2.15 | 1.28 | K₂O | 2.64 | 1.41 |
| Ti | 0.43 | 0.65 | CaO | 2.13 | 1.31 |
| Fe | 11.83 | 17.77 | TiO₂ | 0.86 | 0.43 |
| Mn | | 0.12 | MnO | 0.03 | 0.05 |
| | | | Fe₂O₃ | 1.31 | 9.16 |
| | | | NiO | 0.01 | 0.02 |
| | | | Rb₂O | 0.04 | 0.00 |
| | | | SrO | 0.03 | 0.02 |
| | | | MoO₃ | | 0.01 |

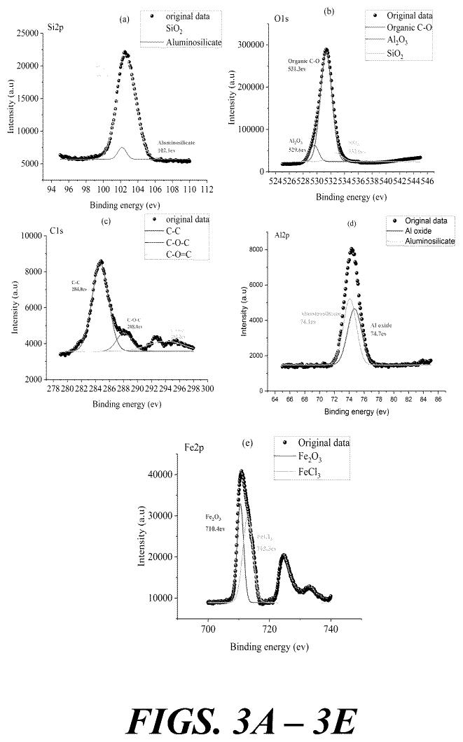

According to the XRD results, as shown in FIG. 2, SiO₂ (silicon dioxide) was the most abundant compound in the raw media with relatively low amounts of Al₂Si₂O₅(OH)₄ (aluminum silicate hydroxide), Fe_{0.946}Ni_{0.054}, and O₂Si₁ (zeolite). However, following filtration of the Canal water, O₂Si₁ (quartz low) emerged as the most predominant compound, while Al₂0₃·2Si0₂·3H₂O (aluminum silicate hydrate), and (Fe_{0.847}Al_{0.153})·(Fe_{1.847}Al_{0.153})·O₄ (iron aluminum oxide) were also observed in the used media. XPS spectra, as shown in FIGS. 3A-3E, are utilized to determine the chemical makeup of functional groups on unprocessed BIPGEM images. In FIGS. 3A-3E, the XPS spectra for five elements at the core level, namely Si 2p, O 1s, C 1s, Al 2p, and Fe 2p peaks, were displayed at their respective binding energies. At binding energies of 102.1 eV and 102.7 eV, the high-resolution Si 2p spectrum of BIPGEM, as shown in FIG. 3A, exhibited two separate peaks, which could be attributed to the aluminosilicate and SiO₂ groups, respectively.

The O 1s spectrum, as shown in FIG. 3B, can be deconvoluted into three different peaks at binding energies of 529.6, 531.3, and 532.6 eV, which are ascribed to the Al₂O₃, organic C—O, and SiO₂ groups, respectively. The C 1s spectrum, as shown in FIG. 3C, can be broken down into three distinct peaks at binding energies of 284.8, 288.0, and 294.2 eV, respectively, attributable to the C—C, C—O, and C—O═C groups, respectively. The high-resolution Al 2p spectrum presented in FIG. 3D can be deconvoluted into two different peaks at binding energies of 74.1 and 74.7 eV, which can be attributed to the aluminum oxide and aluminosilicate groups, respectively. Finally, the high-resolution Fe 2p spectrum, as shown in FIG. 3E, can be deconvoluted into two different peaks at binding energies of 710.4 and 713.3 eV, which are ascribed to the Fe₂O₃ and FeCl₃ groups, respectively. Thus, FIGS. 3A-3E indicated that the compounds likely to facilitate PFAS adsorption include Al oxides, Fe oxides, and carbonic compounds. The original XPS spectra of the BIPGEM components are presented in FIGS. 4A-4E.

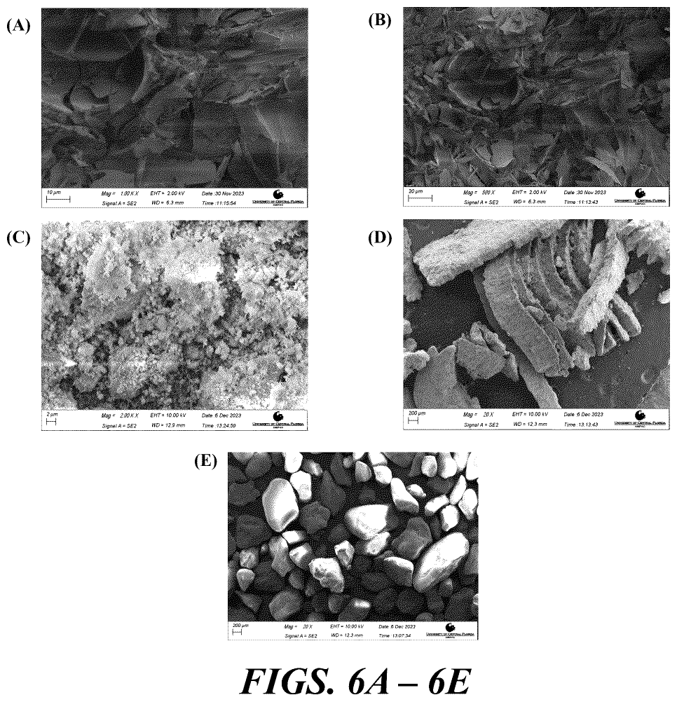

FE-SEM images, as shown in FIG. 5A and FIG. 5C revealed numerous pores in the raw media, particularly in perlite and biochar, providing significant adsorption sites for PFAS. FIG. 5B and FIG. 5D depict amorphous flocs on the surface or inside the pores of perlite and biochar, likely a combination of organic matter complexes, indicating their crucial role in PFAS adsorption compared to FIG. 5A and FIG. 5C. Comparison of FIG. 5E and FIG. 5F indicated that the surface of ZVI became coarser after the experiment, suggesting iron oxidation. Similarly, comparing FIG. 5G and FIG. 5H, the surface of sand appeared coarser too, possibly due to adsorption of organic and particulate matters in the complex canal water matrix. The FE-SEM images of each component of raw BIPGEM are presented in FIGS. 6A-6E.

### Background PFAS Concentrations in the Water Matrix

Based on the samples collected from April to July 2023, PFBS concentration in the C-23 canal was the highest (16.67 ng·L⁻¹), followed by PFOA (15.67 ng·L⁻¹), PFOS (12.29 ng·L⁻¹), PFBA (11.73 ng·L⁻¹), and Gen X (below detection limit), as shown in TABLE 3, provided above. It is noteworthy that from May 2023 to July 2023, the concentration of all PFAS decreased, which might be due to the dilution of PFAS caused by increased precipitation during the rainy season. The levels of PFAS in the canal waters matched those found at different locations in Florida, as shown in TABLE 8, provided below.

TABLE 8

| | PFOA | PFOS | PFBA | PFBS | |
|---|---|---|---|---|---|
| Site | (ng · L⁻¹) | (ng · L⁻¹) | (ng · L⁻¹) | (ng · L⁻¹) | Sample date |
| Okeechobee Utility Authority, FL, US | — | — | 10 | 3.9 | Mar. 1, 2023 |
| Wilson Damn, MN, US | — | — | 1,143.3 | | 2017 |
| Cottage Grove, MN, US | — | — | 754.0 | | 2016 |
| Bradenton, FL, US | | — | 8.5 | 3.9 | Mar. 14, 2023 |
| Houston, TX, US | — | | 0.0-10.6 | | Feb. 6, 2023- |
| | | | | | Mar. 15, 2023 |
| Watsonville, CA, US | 3.1 | 5.2 | — | 4.5 | 2023 |
| Granite State Campground, NH, US | 3.4 | 5.2 | — | — | 2019 |
| Fort Hunter Liggett Water System (GOGO): | 9.0 | 130 | | 28 | 2017-2019 |
| Distribution, Well 236, NH, CA | | | | | |

Long-Chain Vs. Short-Chain PFAS Removal by Individual Media Components

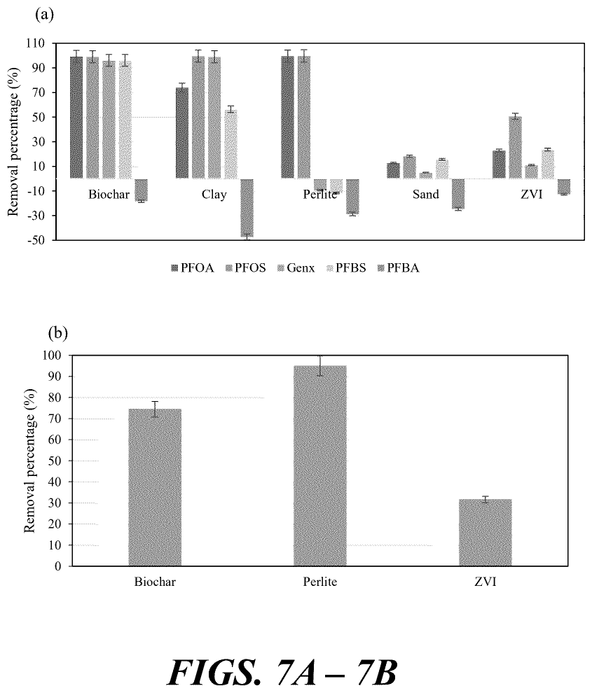

The removal efficiencies of long-chain and short-chain PFAS by biochar, clay, perlite, sand, and ZVI, based on batch adsorption studies, are presented in FIG. 7A. The influent was spiked at 50 μg·mL⁻¹ of each of PFOS, PFOA, PFBS, PFBA, and GenX. The removal efficiencies of PFBA by biochar, perlite, and ZVI based on an influent spiked with 50 μg·mL⁻¹ of PFBA are presented in FIG. 7B. PFAS removal percentage in the water samples was calculated using Eq. 6:

$$\% Removal = ( \frac{{C}_{0} - {C}_{e}}{{C}_{0}} ) * 100 \% \qquad ( 6 )$$

Where C₀ represents the initial concentration of PFAS in the flask in μg·mL⁻¹; and/or Cₑ represents the equilibrium concentration of PFAS in μg·mL⁻¹.

In the solutions of PFAS mixture, biochar, perlite, and clay exhibited excellent removal (98%) of long-chain PFAS (PFOA and PFOS), whereas sand showed the least removal efficiency (up to only 18%). The relatively low removal efficiency (up to approximately 51% for PFOS) of ZVI may be attributed to its low porosity. In the case of GenX, biochar and clay showed significantly high (over 98%) removal efficiency when compared to the other components. For PFBS, biochar exhibited the highest removal percentage, followed by perlite and clay, whereas ZVI and sand showed the least removal of PFBS. None of the five components exhibited appreciable removal of PFBA though. This might be because PFBA had higher solubility in water (at 20° C.-25° C.) compared to PFBS [(46.2˜ 56.6) g· L^{-1] [52}], as indicated by its Log D value as well, as shown in TABLE 2. Besides, short-chain PFAS compete with long-chain PFAS for adsorption sites. When PFBA was tested for adsorption by biochar, perlite, and ZVI individually, it was found that biochar and perlite exhibited reasonable removal efficiency (more than 75%), as shown in FIG. 7B. In general, both long-chain and short-chain PFAS were appreciably adsorbed by biochar, followed by clay, perlite, ZVI, and sand. The sorption coefficient (K_{d}) is the ratio of the concentration of a compound in solid phase to that in liquid phase at equilibrium (Eq. 7):

$${K}_{d} = \frac{{C}_{s}}{{C}_{e}} = \frac{( \frac{{C}_{0} - {C}_{e}}{m} ) V}{{C}_{e}} \qquad ( 7 )$$

Where Cₛ (ng· g⁻¹) represents the concentration in the solid phase at equilibrium; and/or Cₑ (ng·mL⁻¹) represents the concentration in the aqueous phase at equilibrium. Cₛ is calculated using Eq. 8:

$${C}_{s} = ( \frac{{C}_{0} - {C}_{e}}{m} ) V \qquad ( 8 )$$

Where C₀ (ng·mL⁻¹) corresponds to the initial concentration of PFAS added to the flasks, V (mL) is the volume of solution and m (g) is the dry mass of the material. A high value of Cₛ indicated that a greater portion of PFAS was adsorbed to each component of BIPGEM and hence, those PFAS were less mobile. Therefore, as shown in TABLE 9, provided below, long-chain PFAS could be adsorbed to biochar, clay, and perlite very well. The short-chain PFAS, PFBS, and GenX could be adsorbed by biochar and clay, but sand and ZVI offer worse adsorption of these PFAS compounds. The negative K_{d} values for PFBA, consistent with its Log D value reported in TABLE 2, provided above, suggest a tendency for desorption from the media surfaces. This again confirmed that PFBA was less likely to bind to the BIPGEM components and more likely to remain in the aqueous phase. Consequently, the mobility of PFBA in the environment might increase, potentially impacting ecosystems and human health. The comparison with literature values under similar conditions are presented in TABLE 10, provided below.

TABLE 9

| | | Spiked as a mixture of 5 PFAS | | | | |
|---|---|---|---|---|---|---|
| | | Short-chain | | | Long-chain | |
| Component | PFBA only | PFBA | PFBS | GenX | PFOA | PFOS |
| Biochar | 290.03 | | 2,409.47 | 2,411.98 | 12,034.23 | 9,278.58 |
| Clay | — | | 128.59 | 9351.80 | 283.34 | 20,205.16 |
| Perlite | 1861.36 | Negative value | Negative value | | 19,760.10 | 27,183.81 |
| Sand | — | | 18.46 | 5.13 | 14.40 | 22.25 |
| ZVI | 46.09 | | 30.81 | 12.32 | 29.41 | 102.39 |

TABLE 10

| | PFBA | PFBS | GenX | PFOA | PFOS | Reference |
|---|---|---|---|---|---|---|
| GAC | | 9,400 | | 35,000 | 133,000 | [5] |
| PAC | | — | | 250 | 240 | |
| Sediment column | | 10^{\hat{ }1.76} | | 10^{\hat{ }1.12} | 10^{\hat{ }2.13} | [6] |
| Polymer-containing CAC | 1700 | 22,000 | | 265,3000 | 233,000 | [7] |
| Polymer-free CAC* | | 59,000 | | 824,000 | 9,579,000 | |
| SW600 | | 10.24 | 4.67 | 40.74 | | [8] |
| SW600-PPAO | | 1047.13 | 295.12 | 19498 | | |

### Comparison of Long-Chain and Short-Chain PFAS Removal by BIPGEM Media

The removal efficiencies of long- and short-chain PFAS and GenX by BIPGEM media in fixed-bed columns based on a spiked concentration of 70 ng·L⁻¹ of each of the five PFAS are presented in FIG. 8.

PFAS removal percentage in the fixed-bed column was calculated using Eq. 9:

$$\% Removal = ( \frac{{C}_{inf} - {C}_{eff}}{{C}_{inf}} ) * 100 \% \qquad ( 9 )$$

where C_{inf} represents the concentration of PFAS in the column influent in ng·L⁻¹; and/or C_{eff} represents the concentration of PFAS in the column effluent in ng·L⁻¹.

As shown in FIG. 8, all three GSMs (BIPGEM and two other GSM tested in previous studies) could effectively remove PFOS (approximately, 100% by CPS at 32 h, 100% by ZIPGEM at 48 h, 95% by BIPGEM at 36 h). For PFOA, the removal percentage exhibited by the other two GSM mixes (i.e., CPS and ZIPGEM) dropped faster than BIPGEM, with approximately 38% at 12 h for CPS, 29% at 12 h for ZIPGEM, as opposed to approximately 48% at 40 h for BIPGEM. Thus, BIPGEM demonstrated a higher potential to remove short-chain PFAS (i.e., PFBA) compared to CPS and ZIPGEM.

The removal efficiency of long-chain PFAS by BIPGEM was essentially about twice as much as that of short-chain PFAS over the 44-h duration. However, initially, only a difference of about 30% between the removal percentages of long-chain and short-chain PFAS was observed, which was quite reasonable since the column was yet to reach equilibration, leaving adequate sites for short-chain PFAS adsorption. Long-chain PFAS removal efficiency was sustained at a level exceeding 80% during the initial 21 h. Specifically, within the first 6 h, the removal percentage remained consistently above 85%. Subsequently, up until the 44th h, the removal percentage of long-chain PFAS remained above 50%. For short-chain PFAS, a decline was observed from the 4th hour onwards, with the removal percentage ranging between 20% to 40%. Notably, this condition persisted for approximately 40 h, until reaching the 44th h, at which point the removal percentage of short-chain PFAS dropped below 20%.

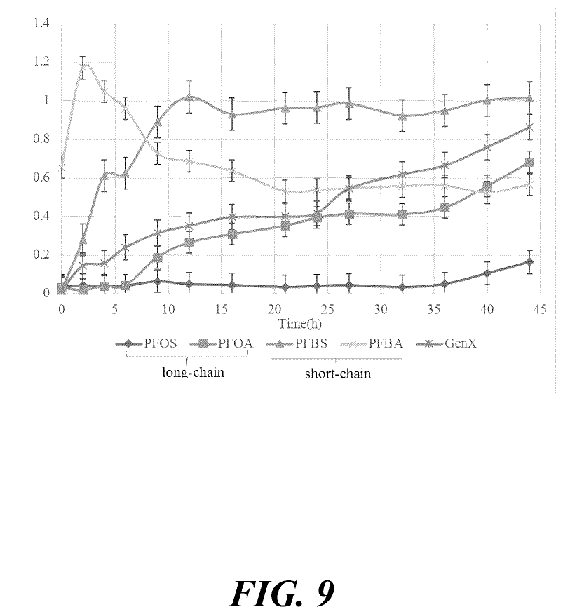

The breakthrough profiles for long-chain PFAS (PFOA and PFOS), as shown in FIG. 9 exhibited a comparatively more gradual rise compared to their short-chain counterparts (PFBS and PFBA). Conversely, the breakthrough trend of GenX falls intermediary between the long-chain and short-chain PFAS. This distinction arose due to the higher water solubility of short-chain PFAS relative to their long-chain counterparts. Consequently, when assessing the effluent concentration from the fixed-bed column, the concentration of short-chain PFAS surpassed that of the long-chain PFAS. As a result, the breakthrough curve for short-chain PFAS (e.g., PFBS), manifested a steeper trajectory. Notably, the breakthrough curve for PFBA displayed the most pronounced initial rise in the effluent, which might be attributed to the competitive adsorption of long-chain PFAS.

### Mechanisms of PFAS Removal Using BIPGEM

The two key mechanisms of PFAS adsorption by a media mix were hydrophobic and electrostatic interactions [53]. Predominantly hydrophobic PFAS, especially PFOS and PFOA, were reported to be removed mainly through hydrophobic interactions with GSM such as ZIPGEM and CPS [38]. According to the Log D values, as shown in TABLE 2, provided above, long-chain PFAS (PFOA and PFOS) are more hydrophobic (Log D greater than 1.0) compared to the short-chain PFAS (PFBA, PFBS). Therefore, the long-chain PFAS were removed by each media component mainly through hydrophobic interactions. It is pertinent to note that when ZVI comes into contact with deionized (DI) water, it acquires a positive charge, indicating that its removal mechanism may be principally governed by electrostatic interaction. However, due to ZVI's limited porosity, its effectiveness in removing PFAS was relatively modest. Similarly, sand exhibited suboptimal performance in the removal of long-chain and short-chain PFAS, owing to its low porosity and negative surface charge. Given the short hydrophobic tail of short-chain PFAS, their primary mode of removal hinges on electrostatic interaction. Nonetheless, this electrostatic interaction was less pronounced compared to its long-chain counterpart. Consequently, the removal efficiency of short-chain PFAS was comparatively decreased. Furthermore, the adsorption of long-chain PFAS indeed exerted an influence on the adsorption of short-chain PFAS. The latter was unable to outcompete the former for adsorption sites due to their lower affinity for adsorption.

In addition to the hydrophobic and electrostatic interactions, which also applied to the BIPGEM column study, ligand exchange may serve as one of the mechanisms for PFAS removal. The process involves the formation of an inner-sphere complex, wherein an organic functional group (such as a hydroxyl or carboxylate) displaces an inorganic hydroxyl or water molecule bound to a metal ion, predominantly Fe or Al, at the surface of a soil mineral [54]. Hydroxyl groups (—OH) can be formed on the surface of metal under certain matrix conditions. The interaction potential and exchangeability of —OH groups provide metal surface reactivity for PFAS adsorption [54]. Hydroxyl groups formed on alumina surfaces may be replaced by PFAS via ligand exchange [55]. The ligand exchange possibly occurs during the adsorption of PFOA onto iron oxide. By dissociating the water molecule from the surface metal center, the protonated hydroxyl groups (Fe³⁺—OH) can be replaced by PFAS anions [56]. ZVI can be oxidized to Fe²⁺ and further to Fe³⁺. Parenky et al. suggested that Fe oxides and dissolved Fe ions originating from ZVI can contribute to PFOS removal. The ligand exchange reaction can be expressed as follows [Eqs. (10) and (11)]. As listed in TABLE 7, Fe and Al were the second and third significant elements (˜ 13% and 12%, respectively) in BIPGEM. Therefore, ligand exchange may also contribute to the PFAS adsorption process.

$${Al}^{3 +} - OH + {{C F}_{3} ( {C F}_{2} )}_{n} {COO}^{-} + {H}^{+} \to {Al}^{3 +} - {OH}_{2} - {OOC ( {C F}_{2} )}_{n} {C F}_{3} \qquad ( 10 )$$

$${Fe}^{3 +} - OH + {{C F}_{3} ( {C F}_{2} )}_{n} {COO}^{-} + {H}^{+} \to {Fe}^{3 +} - {OH}_{2} - {OOC ( {C F}_{2} )}_{n} {C F}_{3} \qquad ( 11 )$$

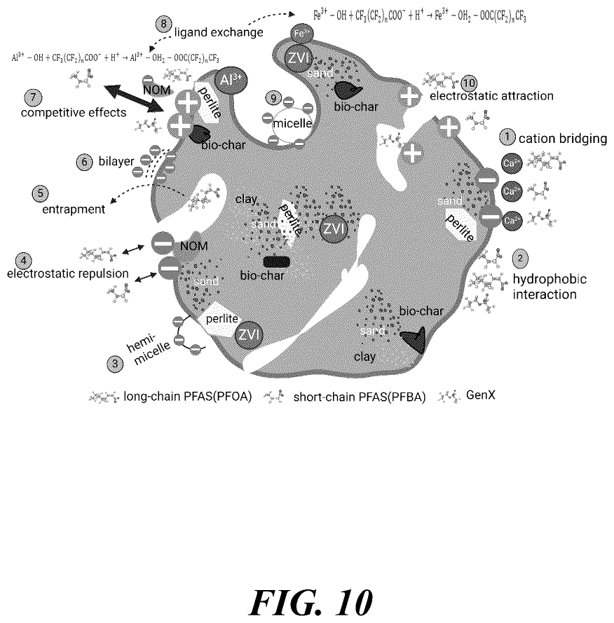

Yu [58] demonstrated that PFOS and PFOA, used typically as surfactants, form hemi-micelles and micelles in water via the hydrophobic aggregation of C—F chains, or forming bilayers [59]. FIG. 10 depicts dominant PFAS removal mechanisms by BIPGEM, Mechanisms such as entrapment may also contribute to the PFAS adsorption process.

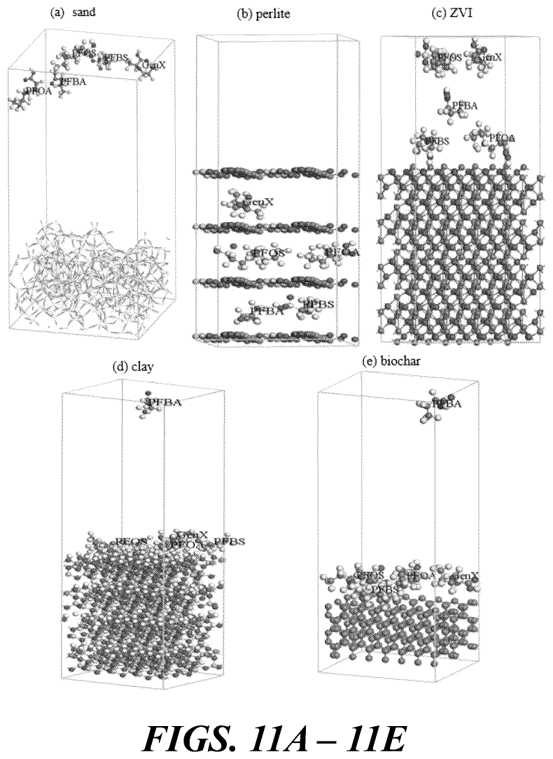

A molecular dynamics (MD) simulation was performed to enhance understanding of the PFAS removal mechanism by each component within BIPGEM. The simulation utilized Materials Studio 2024, which provides a detailed modeling and simulation environment designed to elucidate the complex interactions between a material's atomic and molecular structure, and its properties and behavior. The initial model consisted of a mineral surface and a top vacuum layer, allowing for molecular transit. The initial unit cells were obtained from the American Mineralogist Crystal Structure Database. Consistent segments of mineral structure were split following a crystallographic (0 0 1) direction to form a surface. The construction of supercells 4×2×1, with dimension of 20.59 Å×17.87 Å×45.39 Å, allowed to create surface layers. Energy and geometric optimization utilized the CLAYFF force field, whereas the Ewald summation method applied in computing electrostatic and van der Waals energy. The potential for absorption across various strata was gauged by calculating the adsorption energy, signifying the interaction among layers (Eq. (12)).

$${E}_{i / j} = {E}_{i} + {E}_{j} - {E}_{total} \qquad ( 12 )$$

where Ei/j signifies the energy of interaction between layers i and j, where Ei and Ej denote the energy levels of layers i and j, respectively, and Eₜₒₜₐₗ stands for the cumulative energy of the system comprising layers i and j. Energy E is a combination of van der Waals energy and electrostatic energy. Negative interaction energy indicates an attractive force between elements, while positive adsorption energy indicates a repulsive effect. Greater absolute values of negative adsorption energies correspond to stronger interactions. FIGS. 11A-11E illustrate the simulation results for the adsorption of PFAS on the surfaces of sand, perlite, ZVI, clay, and biochar.

Sand did not contribute to PFAS removal, as shown in FIG. 11A, where all PFAS species remained unadsorbed on the sand surface. Perlite's porous structure allowed PFAS species to penetrate different layers; FIG. 11B indicates that short-chain PFAS entered the inner layer, long-chain PFAS entered the middle layer, and GenX stayed at the third layer, likely interacting with long-chain PFAS. ZVI contributed to the removal of PFBS, PFBA, and PFOA through electrostatic interactions. Clay and biochar are the main components in BIPGEM influencing PFAS removal. FIG. 11D and FIG. 11E show that, except for PFBA, clay and biochar removed the other PFAS, consistent with a Cₛ/C₀ value of approximately 0.5 for PFBA after 22 h in the column study. This aligns with the performance of biochar and perlite in removing only PFBA in the adsorption test while spiking a mixture of PFAS, as shown in FIG. 7A, or only PFBA, as shown in FIG. 7B, in the influent. Additionally, FIG. 11D and FIG. 11E confirm a competitive adsorption between long-chain PFAS and short-chain PFAS, particularly PFBA and long-chain PFAS.

### PFAS Dynamic Adsorption

The BIPGEM was not previously tested for PFAS removal from a surface water matrix. Therefore, to understand the adsorption process and determine the most suitable dynamic model, three different models were evaluated using PFOA, PFOS PFBS, and GenX adsorption data. PFBA was excluded as it did not demonstrate a complete breakthrough curve. For PFOA, the Thomas and Yoon-Nelson models presented strong goodness of fit values (R²=0.83) for each case, whereas the highest goodness of fit for PFOA was found for the MDR models (R²=0.95). For PFOS, which it did not reach exhaustion, the goodness of fit for the three models was low, with values of 0.36 for Thomas and Yoon-Nelson, and 0.16 for MDR model, respectively.

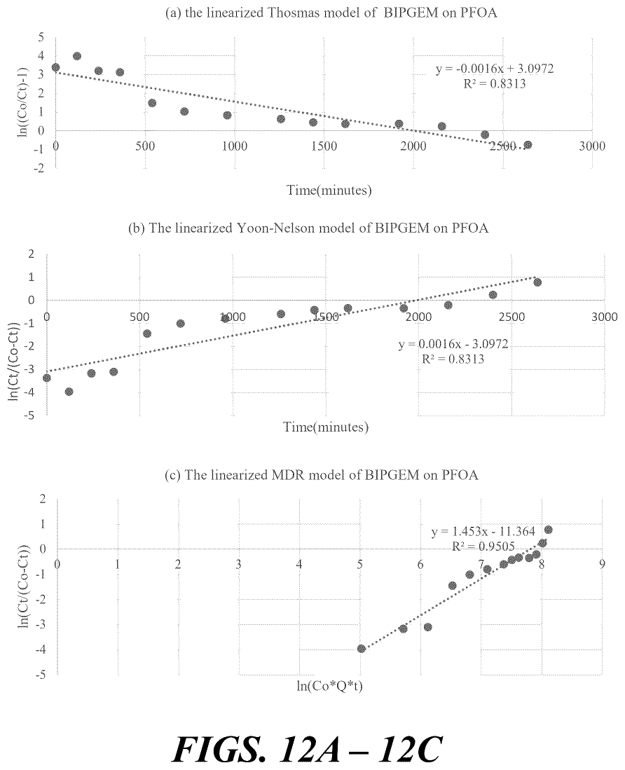

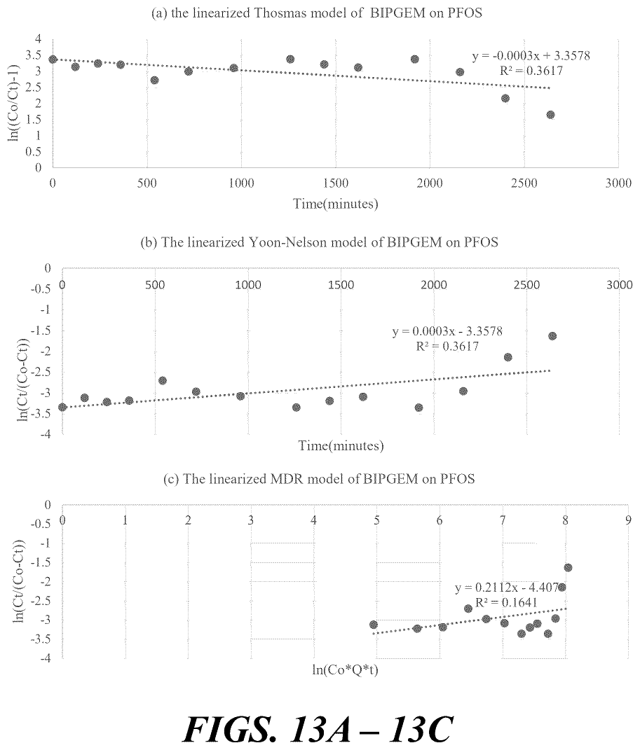

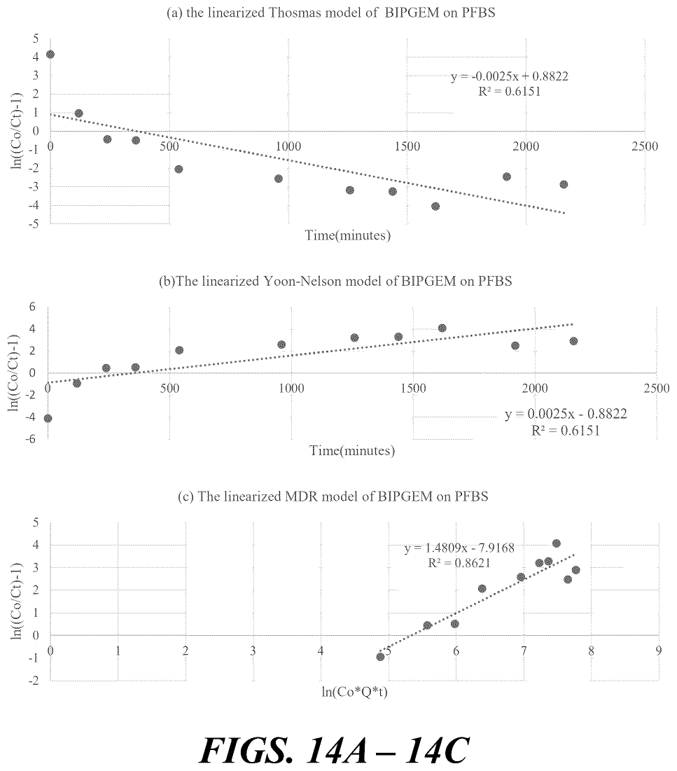

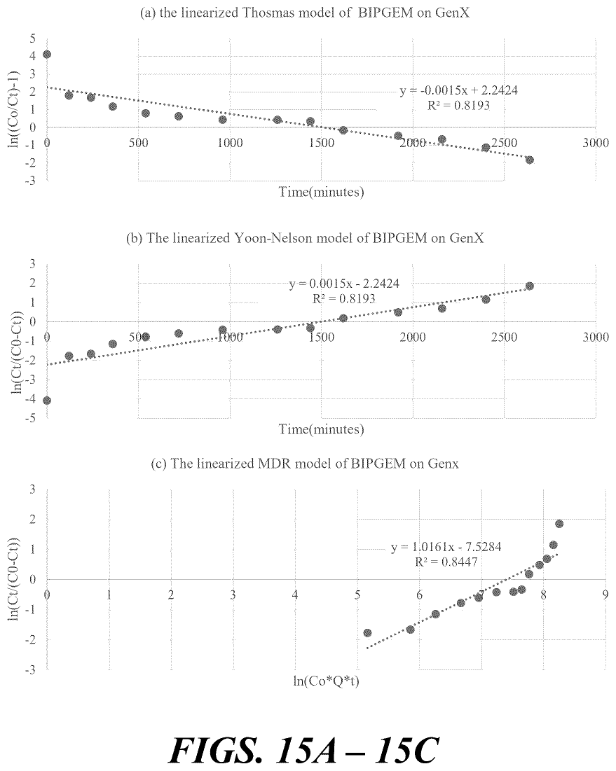

It was important to note that the low goodness of fit value for PFOS does not imply poor removal. Rather, it indicated that these models might not be suitable for describing PFOS adsorption by BIPGEM. For PFBS, the MDR models exhibited higher fitness (R²=0.86), followed by the Thomas and Yoon-Nelson models (R²=0.62). In the case of GenX, the Thomas and Yoon-Nelson models yielded R²=0.82, while the MDR models presented a goodness of fit with R²=0.85, as shown in FIGS. 12A-15.

The better performance and correlation demonstrated by the MDR model for PFAS suggested that the dynamic behavior of the breakthrough curves can be adequately described by Langmuir kinetics of adsorption and second-order reversible reaction kinetics, both of which supported the MDR model. This indicates that PFOA adsorption in the fixed-bed column study may be confined to a single molecular layer onto the media, because the MDR model also accepts the assumptions of Langmuir, i.e., the adsorption of a uniform single-layer of molecules. Consequently, the MDR model was deemed the most suitable for describing PFAS adsorption behavior.

A reduced temporal gap was observed between the breakthrough and exhaustion stages for PFOA over PFOS, as shown in FIG. 9, supported by the large Kth constant and the smaller value (τ) for PFOA in comparison to PFOS. the time difference between the breakthrough and exhaustion points for PFBS was shorter compared to GenX, as shown in FIG. 9 and TABLE 5, provided above, confirmed by the large Kth constant and the smaller τ value for PFBS in relation to GenX, as shown in TABLE 11, provided below. The time required for a 50% breakthrough (τ) was achieved earlier (352.88 min) for PFOA, constituting about 23.6% of the τ for PFOS (1,494.33 min), as shown in TABLE 11. According to MDR model, the maximum adsorption capacity calculated for PFOA and GenX were 0.37 ng· g⁻¹, and 0.245 ng· g⁻¹, respectively.

TABLE 11

| Model | | PFOA | PFOS | PFBS | GenX |
|---|---|---|---|---|---|
| Thomas | R² | 0.83 | 0.36 | 0.62 | 0.82 |
| | Kₜₕ | 1.77E−05 | 3.57E−06 | 3.18E−05 | 1.44E−05 |
| | (L · min⁻¹ · ng⁻¹) | | | | |
| | qₒ(ng · g⁻¹) | 0.364 | 1.957 | 0.058 | 0.32 |
| Yoon- | R² | 0.83 | 0.36 | 0.62 | 0.823 |
| Nelson | K_{YN} | 0.0016 | 0.0003 | 0.0025 | 0.0015 |
| | (min⁻¹) | | | | |
| | τ(minutes) | 1,935.75 | 11,192.67 | 352.88 | 1,494.93 |
| MDR | R² | 0.95 | 0.16 | 0.86 | 0.85 |
| | a_{mdr} | 1.45 | 0.21 | 1.48 | 1.02 |
| | qₒ(ng · g⁻¹) | 0.370 | — | 0.031 | 0.245 |

### Statistical Analysis

### ANOVA Analysis

The ANOVA test, as shown in TABLE 12, provided below, confirmed that there was a significant difference between the removal efficiencies of PFBA with and without the presence of other PFAS (PFOA, PFOS, PFBS, GenX) [F-value (20.91)>F-critical (7.71)]. Hence, one should reject the null hypothesis confirming that the removal percentage of PFBA was significantly different with and without the presence of other PFAS at a 95% confidence level.

TABLE 12

| | | Sum of | Degrees of | Mean | F | |
|---|---|---|---|---|---|---|
| | Source | squares | freedom | square | statistic | p-value |
| Hypotheses 1 | Between | 1.14 | 1 | 1.14 | 20.91 | 0.01 |
| | groups | | | | | |
| | Within group | 0.22 | 4 | 0.05 | | |
| | Total | 1.36 | 5 | | | |
| Hypotheses 2 | Between | 2.22 | 2 | 1.11 | 37.37 | 8.61e−10 |
| | groups | | | | | |
| | Within group | 1.16 | 39 | 0.03 | | |
| | Total | 3.38 | 41 | | | |

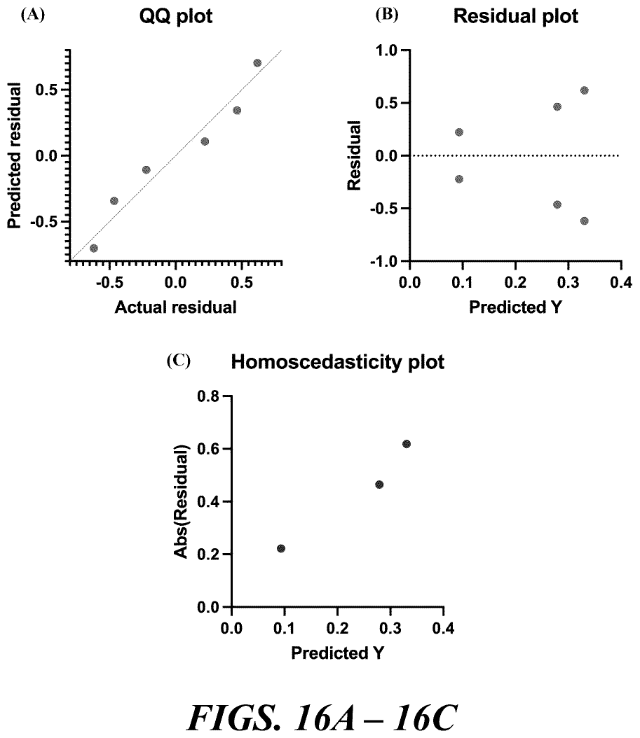

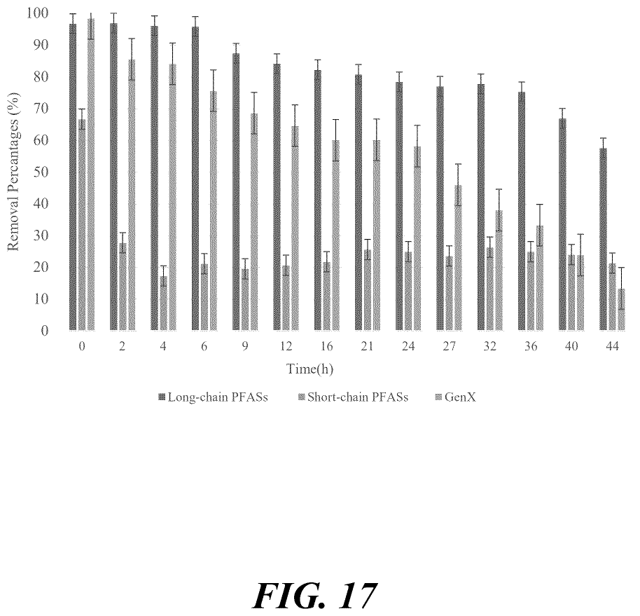

The ANOVA test also confirmed that there was a significant difference between the removal efficiencies of long-chain PFAS (PFOA and PFOS), short-chain PFAS (PFBS and PFBA), and GenX [F-value (37.37)>F-critical (3.45)], and hence, one should reject the null hypothesis confirming that the removal percentage of long-chain and short-chain PFAS, and GenX were significantly different at a 95% confidence level. The residual analysis confirmed and validated the assumptions of ANOVA, as shown in FIG. 16 and FIG. 17. Hence, a pair of null hypotheses listed in TABLE 6, disclosed above, were rejected.

### Response Surface Plot

A central composite design was employed for statistical modeling, optimization, and determining the relationship among experimental variables. The experimental results with coded levels of independent variables including pH, ammonia (mg·L⁻¹), Ca (mg·L⁻¹), Fe (mg·L⁻¹), Mg (mg·L⁻¹), total organic carbon (TOC) (mg·L⁻¹), and dissolved organic carbon (DOC) (mg·L⁻¹) in the effluent were obtained. The predicted second-order polynomial models for target PFAS removal efficiency (R %) are given by Eqs. 13 through 17.

$$PFOA removal percentage ( \% ) = - 266.1 + 4.233 {X}_{1} + 30.73 {X}_{2} - 0.3134 {X}_{3} + 81.03 {X}_{4} - 9.01 {X}_{5} - 0.5431 {X}_{6} + 0.02255 {X}_{7} - 0.1985 {{X}_{1}}^{2} - 165.5 {{X}_{2}}^{2} + 0.003534 {{X}_{3}}^{2} - 4.893 {{X}_{4}}^{2} + 0.32 {{X}_{5}}^{2} + 0.02103 {{X}_{6}}^{2} \qquad ( 13 )$$

$$PFOS removal percentage ( \% ) = - 109.3 + 0.072 {X}_{1} - 0.229 {X}_{2} - 0.119 {X}_{3} - 0.18 {X}_{4} - 0.36 {X}_{6} - 0.45 {X}_{7} + 0.62 {X}_{1} * {X}_{2} - 0.82 {X}_{1} * {X}_{3} - 0.71 {X}_{2} \times {X}_{3} + 0.37 {{X}_{4}}^{2} + 0.72 {X}_{3} \times {X}_{4} + 0.74 {X}_{4} \times {X}_{6} + 5.56 {{X}_{4}}^{2} + 0.002222 {{X}_{3}}^{2} \qquad ( 14 )$$

$$GenX removal percentage ( \% ) = - 139.6 + 2.369 {X}_{1} + 14.94 {X}_{2} - 0.2328 {X}_{3} + 42.47 {X}_{4} - 4.168 {X}_{5} - 0.3529 {X}_{6} + 0.06901 {X}_{7} - 0.1119 {{X}_{1}}^{2} - 87.52 {{X}_{2}}^{2} + 0.002305 {{X}_{3}}^{2} - 2.573 {{X}_{4}}^{2} + 0.1464 {{X}_{5}}^{2} + 0.01079 {{X}_{6}}^{2} \qquad ( 15 )$$

$$PFBS removal percentage ( \% ) = - 310.25 - 32.4299 {X}_{1} - 40.6967 {X}_{2} \qquad ( 16 )$$

$$5.0184 {X}_{3} + 662.692 {X}_{4} + 59.2177 {X}_{5} - 1.35794 {X}_{6} + 0.616036 {X}_{7} + 1.57945 {{X}_{1}}^{2} + 226.481 {{X}_{2}}^{2} + 0.032835 {{X}_{3}}^{2} - 38.3917 {{X}_{4}}^{2} - 1.98185 {{X}_{5}}^{2}$$

$$PFBA removal percentage ( \% ) = - 224.807 - 0.353294 {X}_{1} - 1.0336 {X}_{2} + 0.151054 {X}_{3} + 5.2129 {X}_{4} - 0.032582 {X}_{6} + 0.020264 {{X}_{1}}^{2} + 1.6051 {X}_{3} \times {X}_{4} + 0.001293 {X}_{1} \times {X}_{3} - 3.05289 {X}_{1} \times {X}_{4} 0.027586 {X}_{1} \times {X}_{6} \qquad ( 17 )$$

Where, X₁ represents ammonia concentration (mg·L⁻¹); X₂ represents the dissolved Fe concentration (mg·L⁻¹); X₃ represents the dissolved Ca concentration (mg·L⁻¹); X₄ represents the pH; X₅ represents the dissolved Mg concentration (mg·L⁻¹); X₆ represents the TOC concentration (mg·L⁻¹); and X₇ represents DOC concentration (mg·L⁻¹) in the effluent.

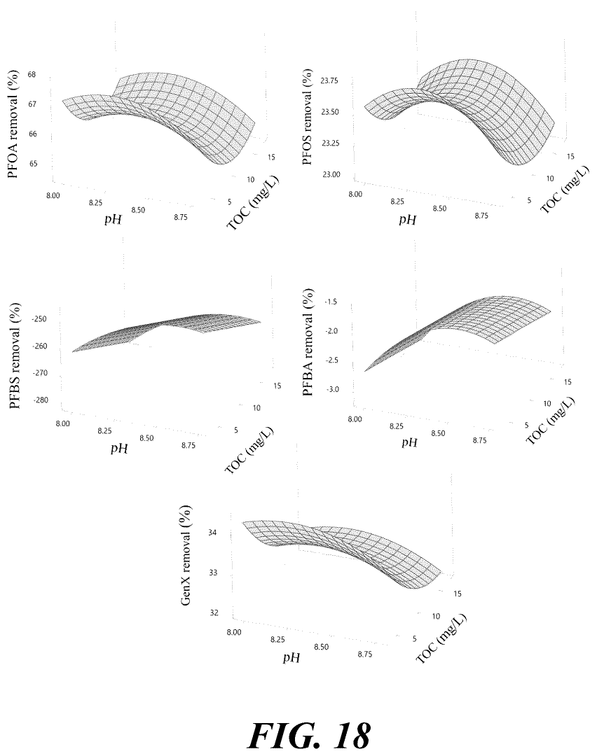

The interactions between the independent variables and their combined effects on PFAS removal efficiency were investigated using the three-dimensional (3D) response surface plots. The 3D plots depicted in FIG. 18 illustrate the removal efficiencies of five PFAS in response to the combined effects of pH and TOC. The impact of pH variation on PFAS removal percentages exhibited distinct patterns. Specifically, the long-chain PFAS (PFOS and PFOA) manifested a discernible convex relationship with effluent pH, with a diminishing degree of convexity observed as the PFAS chain length decreased. Within the pH range of 8.0-8.3, the removal percentages of all five PFAS increased, followed by a decline when pH exceeded 8.3.

The influence of TOC concentration on removal percentages depended on the PFAS chain length as well. For instance, a linear relationship existed between TOC concentration and short-chain PFAS (PFBA and PFBS), wherein and increase in effluent TOC resulted in a reduction of PFBA and PFBS removal percentages. While the effluent TOC concentration may not precisely mirror that inside the column, it serves as a representative measure of pore water TOC concentration. Consequently, increased TOC concentration (i.e., increased presence of natural organic matter [NOM]) imparted a progressively negative charge to the media, promoting electrostatic repulsion between BIPGEM and short-chain PFAS. Conversely, a concave relationship was observed between long-chain PFAS (PFOA and PFOS) and GenX, and effluent TOC concentration. Within the TOC range of 5-10 mg·L⁻¹, an increase in effluent TOC concentration enhanced the electrostatic repulsion between BIPGEM and long-chain PFAS, resulting in diminished removal percentages of PFOA, PFOS, and GenX.

### Discussion

### The Role of Biochar in PFAS Removal

During the adsorption test, biochar exhibited 99% removal rate for long-chain PFAS, while exhibiting poor removal of PFBA when the influent was spiked with five PFAS. However, biochar demonstrated 75% removal rate of PFBA when the influent was only spiked with PFBA. This underscores biochar's potential for adsorbing both long-chain and short-chain PFAS. Nevertheless, it is crucial to consider influent conditions to achieve high removal rates. This is due to the well-documented influence of background parameters in water, which can diminish the selective sorption affinity of sorbents for PFAS through mechanisms such as direct competition for adsorption sites, pore blockage, or alterations in the surface charge of biochar [60].

Typically, biochar surfaces are hydrophobic, which facilitates the adsorption of hydrophobic PFAS (C—C bonds) via hydrophobic interactions. The PZC for biochar was at pH=10.7, as shown in FIG. 1, and given the canal water's pH of 7.82-9.03, as shown in TABLE 13, provided below, the biochar exhibits a positive charge, suggesting its potential to electrostatically absorb anionic PFAS. Additionally, the distribution coefficient (K_{d}) values for PFOA and PFOS were 14.40 and 22.25 for sand, respectively, whereas for biochar, the K_{d} values for PFOA and PFOS were 12,034.23 and 9,278.58, respectively. This indicates that the inclusion of biochar in the media matrix reduces the mobility of PFOA and PFOS in the water-solid system, consistent with the findings of Guo et al. [61]. Furthermore, the ability of biochar to remove PFOA may also be attributed to the presence of bivalent and monovalent cations (i.e., P, Ca, Mg), as shown in TABLE 13, in the canal water, which have a higher potential to form complex salts as these cations can be adsorbed onto negatively charged media surfaces such perlite, clay, and ZVI [62]. Furthermore, the ability of biochar to remove PFOA may also be attributed to the presence of bivalent and monovalent cations (i.e., P, Ca, Mg), as shown in TABLE 13, in the canal water, which have a higher potential to form complex salts as these cations can be adsorbed onto negatively charged media surfaces such as perlite, clay, and ZVI [62].

TABLE 13

| Event | Date | Climate condition | TP (mg/L) | pH | Ca (mg/L) | Mg (mg/L) |
|---|---|---|---|---|---|---|
| 1 | Mar. 1, 2023 | dry | 0.05 | 8.4 | — | — |
| 2 | Mar. 14, 2023 | dry | 0.07 | 8.7 | — | — |
| 3 | Mar. 28, 2023 | dry | 0.08 | 8.26 | — | — |
| 4 | Apr. 11, 2023 | dry | 0.06 | 9.03 | — | — |
| 5 | Apr. 25, 2023 | dry | 0.05 | 8.9 | 91.3 | 12.2 |
| 6 | May 9, 2023 | wet | 0.05 | 8.6 | — | — |
| 7 | May 23, 2023 | wet | 0.09 | 8.4 | 88.9 | 13.9 |
| 8 | Jun. 6, 2023 | wet | 0.07 | 8.25 | — | — |
| 9 | Jun. 20, 2023 | wet | 0.15 | 8.35 | — | — |
| 10 | Jul. 3, 2023 | wet | 0.21 | 7.82 | 59.8 | 3.79 |

The high removal of PFOA is primarily due to the physicochemical properties of biochar, including appropriate pore dimensions, extensive specific surface area, and superior hydrophobicity. The temperature during pyrolysis significantly affects the surface characteristics of biochar and its PFAS adsorption capacity [63]. According to Plantonix Inc., our biochar underwent an extended pyrolysis carbonization process at temperatures ranging from 500° C. to 800° C. Compared to other raw materials such as biosolids, our biochar likely possesses higher carbon content, porosity, and surface area, making it more effective at adsorbing PFAS [64]. As the temperature increases (from 500° C. to 800° C.), the volatile elements within the biochar undergo gradual pyrolysis and separation [65], resulting in the formation of new, irregular pores. This process accelerates the breakdown of acidic functional groups (i.e., —COOH, —PhOH, —OH) [66], and increases the proportion of basic functional groups (i.e., —NH₂, pyridinic-N). Additionally, the synthesis of compounds such as KOH, NaOH, MgCO₃, and CaCO₃, may be promoted by the presence of alkali metals (such as Na, K) or alkaline earth metals (like Ca, Mg) [67]. Changes in the functional group could increase the biochar's PZC, potentially exceeding 9.

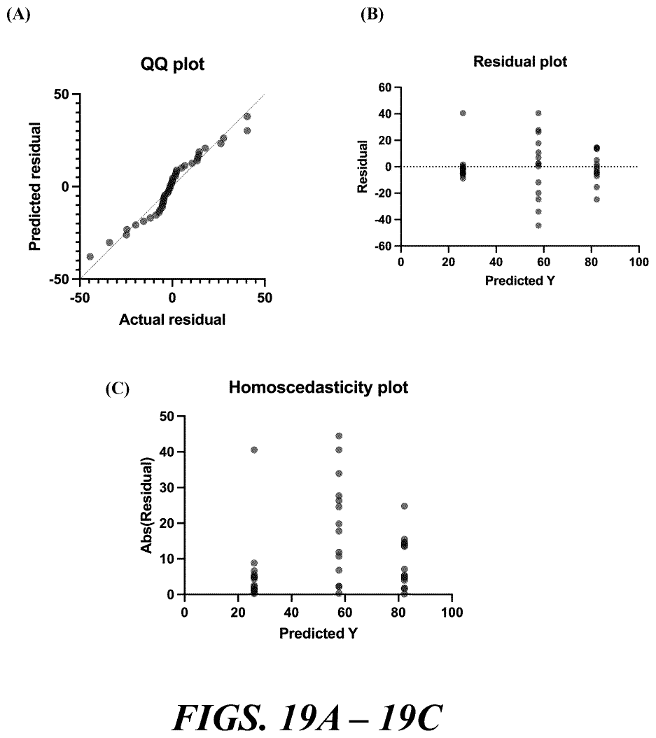

Under elevated pyrolysis temperatures, decarbonylation processes occur [68], resulting in the loss of polar functional groups, and the destruct of aliphatic alkyl, ester C═O, and phenolic groups [61]. This leads to an increase in the aromaticity and hydrophobicity of biochar. Along with changes in functional groups, the surface area of biochar expands due to depletion of free water, hemicellulose, and cellulose [68]. sources of biochar are softwood and tree trimmings, the abundant lignin content correlates well with higher aromatic carbon in biochar, enhancing its enhanced stability and hydrophobic nature [69]. Non-polar aromatic rings, with evenly distributed electron density from x-electrons, reduce interaction with polar water molecules, consequently increasing hydrophobicity. Aromatic compounds engage in van der Waals forces (dispersion forces) among themselves, leading to the aggregation of aromatic compounds and their affinity for non-polar environments. As the levels of aromatic carbon rise, the molecular surface area also increases. This expanded surface area facilitates more hydrophobic interactions with other non-polar molecules, thereby reducing their solubility in water. The dynamic long- and short-chain PFAS and GenX adsorptive removal percentage of BIPGEM can be summarized by FIGS. 16A-16C and FIGS. 19A-19C.

### Competitive Effects on Adsorptive Interactions

In this study, the competitive effects encompass not only the competition between long-chain PFAS and short-chain PFAS but also the interplay between NOM and PFAS. The competitive dynamics between long- and short-chain PFAS were demonstrated through the adsorption test, both with and without the presence of long-chain compounds. Perlite and biochar demonstrated noteworthy removal rates, recording at 95% and 75%, respectively, for PFBA when the influent was solely spiked with 50 μg·mL⁻¹ of PFBA. However, neither perlite nor biochar exhibited any capacity to remove PFBA when the influent was spiked with a mixture of all five PFAS. This highlights the influence of PFAS chain length on adsorption behavior, aligning with the findings of Zhang et al. [70], who elucidated that long-chain PFAS displace short-chain PFAS from the outermost sites of GAC, while unable to displace them from internal sites (micropores) due to size constraints.

Our column study did not explore the potential impact of nutrients on PFAS adsorption. Nevertheless, previous work by Valencia et al. demonstrated that NOM exerts a negative catalytic effect on PFAS adsorption onto negatively charged surfaces, a phenomenon likely induced by long-chain PFAS and other background anions such as bicarbonate (HCO₃⁻) and sulfate (SO₄²⁻), especially when utilizing the same source (canal water) and spiking it to an equivalent concentration. Xiao et al. and Zhang et al. [70] further emphasized that this competitive effect was more obvious in the early stages of adsorption. This is consistent with the breakthrough curve of PFBA in this study. Additionally, the influence of cations (Mg²⁺, Al³⁺, Fe²⁺, Ca²⁺, Fe³⁺) on competitive effects was evident, with the negative impact gradually diminishing over time. This might explain why the removal rate of PFBA remained above 50% even after 40 h of column run.

Spearman's correlation was employed to assess the effects of water quality parameters (ammonia, magnesium, calcium, pH, iron, TOC, and DOC) on PFAS removal as well as the effect of the presence of long-chain PFAS on the removal of short-chain PFAS by BIPGEM. As depicted in FIG. 10, PFOA and GenX removals display a significant negative correlation with the removal of PFBA (Spearman's correlation coefficient of −0.87 and −0.85, respectively), indicating a competitive adsorption between PFOA/GenX and PFBA. However, PFOS did not demonstrate a competitive relationship with PFBA. Consistent with the observation of Maimai et al. [72], this was likely due to the preferential adsorption of PFOS owing to the functional groups of the two compounds with hydrophobicity. According to the Log D of the tested PFAS, as shown in TABLE 2, provided above, PFOS was the most hydrophobic while PFBA was the least hydrophobic PFAS. This implies that the hydrophobic interactions played a key role in the competitive adsorption of different PFAS on BIPGEM.

### Effects of Water Quality Parameters on PFAS Removal

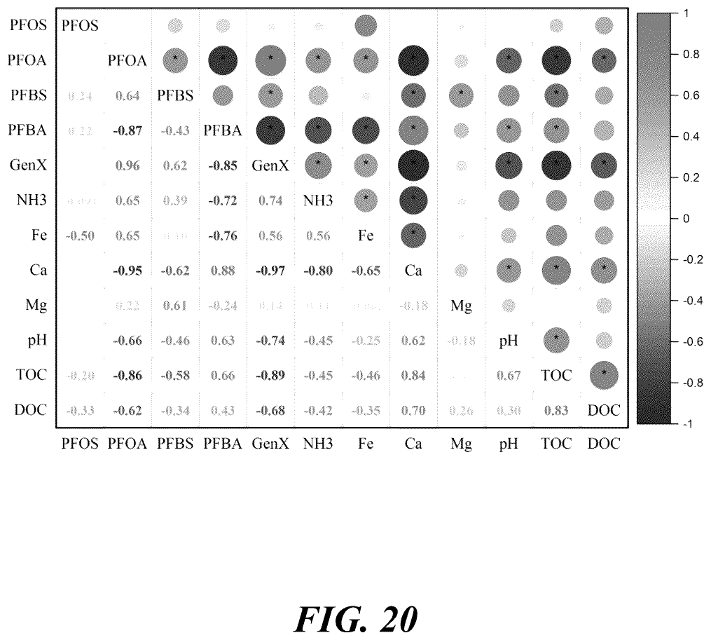

The top right triangle, as shown in FIG. 20, indicates the significance of the correlation at level of 0.05 (p≤0.05) with the corresponding correlation coefficients mapped in the mirrored triangle in the left. Red circles or numbers denote a positive correlation, while blue circles or numbers indicate a negative correlation in the correlation heatmap.

As depicted in FIG. 20, PFOS removal percentage was not significantly correlated with pH, effluent cations (iron, calcium, ammonia, magnesium), and organic matter (TOC and DOC), implying that PFOS removal was governed by its interaction (hydrophobic) with the media rather than with the water constituents. The effluent concentration of calcium (Ca) was significantly negatively correlated with the removal percentage of PFOA, PFBS, and GenX, suggesting that calcium may retain PFAS anions in the aqueous phase. Given the relatively steady concentration of Ca in the influent, a higher concentration in the effluent indicates limited interactions of Ca with the media components and thereby, lower media retention of PFOA, PFBS, and GenX that mostly remain in the aqueous phase. For PFBA, however, the effluent concentration of Ca was significantly positively correlated with the removal percentage of PFBA. Being the smallest (MW=214 g·mol⁻¹) of the PFAS molecules tested in this study, Ca-bound PFBA may be absorbed inside the media pores. Consistent with the bridging effect of Ca, the effluent pH was found to be negatively correlated with the removal percentages of PFOA, PFBS, and GenX. Based on their pKₐ values, as shown in TABLE 2, provided above, these anionic compounds were likely to undergo enhanced association with Ca at increased pH and hence, less retention by the media as discussed earlier.

The effluent concentration of iron (Fe) was significantly positively correlated with the removal rate of PFOA and GenX, while significantly negatively correlated with the removal rate of PFBA. This suggests that iron may only retain PFBA anions in the aqueous phase but contributes to the removal of PFOA and GenX by electrostatic interactions. However, as listed in TABLE 7, raw BIPGEM contains approximately 11.83% of iron, which may enhance PFAS removal by the media through electrostatic interactions. The effluent TOC and DOC concentrations showed a similar significantly inverse relationship with the removal percentage of PFOA, PFBS and GenX. This could be due to the competition between NOM and PFAS for the media adsorption sites as well as the electrostatic repulsion imparted by the NOM molecules adsorbed onto the media [73,74]. Being the smallest of the PFAS molecules, the adsorption of PFBA was not hindered much by NOM adsorption onto the media [75,76].

The cations released from BIPGEM contribute to PFAS removal by enhancing hydrophobic interactions between BIPGEM components (e.g., biochar) and the hydrophobic tail of PFAS molecules. Metal ions may serve as connectors among the hydrophilic carboxyl groups in organic carbon [77], thus enhancing hydrophobic interactions [78]. This contribution decreases as the chain length decreases from PFOA to PFBS. However, the anions released from BIPGEM, such as dissolved or particulate organic matter, increase repulsions between negatively charge surfaces and the anionic head groups of PFAS.

### Conclusion

This study investigated the removal efficiency and removal mechanisms of PFOA, PFOS, PFBA, PFBS, and GenX from a surface water when using BIPGEM media components individually via a batch adsorption test and BIPGEM media mix via a dynamic fixed-bed column study. The adsorption study demonstrated that long-chain PFAS were primarily removed by each component through hydrophobic and electrostatic interactions. Owing to the weak electrostatic interaction exhibited by short-chain PFAS and BIPGEM, their removal percentage was comparatively low. Conversely, the removal of short-chain PFAS through adsorption was challenging, likely because they do not readily bind to particles and remain soluble in water. However, the adsorption of long-chain PFAS had an evident influence on the adsorption of short-chain PFAS, with the latter being unable to outcompete the former for adsorption sites, attributable to the higher sorption coefficients of long-chain PFAS. In the fixed-bed column study, BIPGEM exhibited better performance in removing long-chain PFAS from C-23 canal water when compared to that of short-chain PFAS. This enhanced efficiency in removing long-chain PFAS could be attributed to the extensive surface size of BIPGEM and its positive surface charge (observed at pH levels below PZC that was 11.5).

In the newly developed specialty adsorbent (BIPGEM), biochar played a significant role in achieving complete removal of PFOA and attaining fair removal percentages for short-chain PFAS. However, the contribution of biochar, like the other constituents, on PFAS removal was dependent on competitive adsorption, and hydrophobic and electrostatic interactions driven by various water quality parameters (e.g., cations, NOM, pH). It was imperative to acknowledge that the spent filtration media would necessitate final disposal, as such sorption processes may not entail the destruction of PFAS. Finally, future studies should investigate the intricate interplay between nutrients and the mechanisms governing PFAS adsorption and removal, in order to gain a comprehensive understanding of the competitive and synergistic effects at play in surface water matrices.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### Glossary of Claim Terms

As used herein, the term “Adsorption Capacity” generally refers to the maximum quantity of a compound that can be retained by a specified amount of media under defined conditions. Adsorption capacity may be influenced by the surface area, pore structure, and surface chemistry of the media, and can be expressed in units such as ng/g. The value can be determined through experimental models like Thomas, Yoon-Nelson, or MDR, and may vary based on the specific PFAS compound tested and the media formulation used. This parameter can serve as a key metric in evaluating media performance in fixed-bed filtration systems.

As used herein, the term “Adsorptive Interaction” generally refers to the combination of physical or chemical mechanisms by which substances may adhere to the surface or pores of a media. These interactions can include hydrophobic attraction, ligand exchange, van der Waals forces, or ionic bonding, and may vary in strength and specificity depending on the target substance and environmental conditions.

As used herein, the term “Anionic Contaminants” generally refers to substances bearing a net negative charge in aqueous solutions, which can include species such as PFAS, nitrates, or phosphates. These contaminants may be selectively retained through electrostatic attraction by positively charged media or through ligand-exchange reactions at specific surface sites.

As used herein, the term “Bed Depth” generally refers to the vertical extent of the packed filtration media column through which fluid may pass. Bed depth can influence residence time and treatment capacity and may be configured to allow differential retention of various molecular species based on mobility or size exclusion.

As used herein, the term “Breakthrough Time” generally refers to the duration or volumetric flow until the concentration of a contaminant in the effluent exceeds a defined threshold. This parameter may be used to quantify media exhaustion and to determine operational lifespans of treatment beds

As used herein, the term “Biochar” generally refers to a carbon-rich solid that may be produced through pyrolysis of organic biomass such as wood or agricultural byproducts, under limited oxygen conditions. Biochar can exhibit hydrophobic surfaces and may contain functional groups that can promote electrostatic interaction or ligand exchange with target contaminants. In certain embodiments, biochar can be configured to improve adsorption of both long-chain and short-chain PFAS in aqueous matrices, and its performance may be enhanced by surface area, porosity, or chemical modification.

As used herein, the term “Breakthrough Curve” generally refers to a plot or mathematical representation that can describe the performance of an adsorbent bed over time, typically showing the effluent concentration of a target contaminant relative to time or volume processed. Breakthrough curves may help quantify metrics including breakpoint, mass transfer zone, exhaustion point, and operating point, and can be applied to assess the feasibility of fixed-bed filtration systems under different hydraulic and loading conditions.

As used herein, the term “Clay” generally refers to a naturally occurring, fine-grained aluminosilicate material that can be included in a filtration media blend to enhance the sorption of polar or anionic contaminants. Clay may possess surface functional groups that can interact with PFAS via electrostatic mechanisms and can improve particle packing, porosity, and matrix integrity. Depending on the pH and background chemistry, clay can exhibit variable surface charge properties that may influence PFAS retention performance.

As used herein, the term “Column Packing” generally refers to the process of filling a treatment vessel with one or more adsorptive materials to form a porous bed. The configuration and uniformity of packing may influence hydraulic conductivity and contact efficiency between the target contaminant and the media.

As used herein, the term “Darcy Flux” generally refers to the volumetric flow rate of water per unit area of porous media, which can be used to characterize the hydraulic performance of a treatment bed. Darcy flux may be affected by media porosity, particle size, and compaction, and can influence the residence time of contaminants in the media. A higher Darcy flux can correspond to increased mass transfer potential but may reduce contact time, which can affect PFAS adsorption efficiency depending on the target compound and media configuration.

As used herein, the term “Distribution Coefficient” generally refers to the ratio of a contaminant's concentration adsorbed onto a solid phase to its concentration in the aqueous phase at equilibrium. This value, commonly denoted as K_{D}, can indicate the affinity of a specific media for PFAS under test conditions. The K_{D} can vary between PFAS species and media types, and may be used to predict contaminant mobility and retention performance in environmental applications.

As used herein, the term “Electrostatic Interaction” generally refers to the attraction or repulsion that can occur between charged species, such as between anionic PFAS molecules and positively charged adsorption sites on media like biochar or ZVI. This interaction can be influenced by factors including pH, ionic strength, and the surface potential of the media, and may serve as a mechanism to retain PFAS on solid phases during water treatment processes.

As used herein, the term “Fixed-Bed Column” generally refers to a type of experimental or field-scale configuration in which a packed media is used for continuous flow treatment of water. Fixed-bed columns can be used to simulate real-world conditions and to evaluate removal efficiencies, breakthrough times, and operational performance for PFAS remediation using a defined volume of adsorbent material.

As used herein, the term “Flow-Through Operation” generally refers to the passage of fluid through a filtration system under gravity or pressure. Flow-through may ensure consistent contact with the media and allow continuous removal of dissolved substances over operational cycles.

As used herein, the term “GenX” generally refers to hexafluoropropylene oxide dimer acid (HFPO-DA), a short-chain perfluoroalkyl substance that may be used as a replacement for longer-chain PFAS. GenX can be more water-soluble and mobile than long-chain analogs, and may be resistant to conventional treatment methods. GenX can be present in surface or groundwater sources and may be partially removed through tailored adsorbents exhibiting multiple removal mechanisms.

As used herein, the term “Green Sorption Media” generally refers to a filtration media composed of natural and/or recycled materials, which may be used to perform targeted contaminant removal in a sustainable or cost-effective manner. The green media may include materials such as biochar, perlite, ZVI, and clay blended with sand, and can be deployed in ex situ or in situ configurations for water treatment applications involving PFAS.

As used herein, the term “Head Loss” generally refers to the reduction in fluid pressure or energy as water moves through a media column, often caused by friction, channeling, or compaction. This parameter may be monitored to assess media fouling or to ensure hydraulic stability in long-term operation.

As used herein, the term “Hydraulic Conductivity” generally refers to the ability of a porous material to allow the passage of water through its interconnected voids, often measured in m·s⁻¹. This property may be influenced by media composition, grain size, and porosity. Higher hydraulic conductivity can result in increased flow rates, impacting residence time and potentially affecting the adsorption efficiency for contaminants like PFAS.

As used herein, the term “Hydrophobic Interaction” generally refers to a type of non-covalent bonding where hydrophobic molecules may preferentially associate with hydrophobic surfaces to minimize their exposure to water. In the context of PFAS removal, this mechanism can be exploited using hydrophobic surfaces of materials such as biochar to retain long-chain PFAS compounds that exhibit low water solubility and high fluorine content.

As used herein, the term “Ligand Exchange” generally refers to a process where a functional group on a solid media surface, such as a hydroxyl (—OH), can be replaced by an incoming anion such as PFAS through the formation of a new coordination bond. This mechanism may be promoted on media containing metal oxides (e.g., iron or aluminum), and can be a contributing factor in PFAS immobilization under certain chemical conditions.

As used herein, the term “Media Matrix” generally refers to the bulk composition or configuration of individual materials blended to form a functional adsorbent system. This matrix can comprise varying proportions of sand, biochar, perlite, clay, and ZVI, and may be optimized for surface area, porosity, pH stability, or removal performance depending on the application scenario.

As used herein, the term “Micropore Volume” generally refers to the cumulative internal pore space of a material that may have diameters less than 2 nanometers. This volume can contribute significantly to adsorption of small molecules and may be engineered by activation processes in materials like biochar.

As used herein, the term “Per- And Polyfluoroalkyl Substances” (PFAS) generally refers to a class of synthetic fluorinated organic compounds that may include both perfluoroalkyl (fully fluorinated carbon chains) and polyfluoroalkyl (partially fluorinated carbon chains) species. These substances can be used in industrial and commercial products due to their hydrophobic and lipophobic properties and may persist in the environment, requiring specialized treatment for removal from water sources.

As used herein, the term “Perlite” generally refers to a naturally occurring amorphous volcanic glass that may expand upon heating to produce a porous material. Perlite can be incorporated into sorbent media blends due to its low density, internal pore structure, and surface chemistry that can facilitate contaminant retention, including electrostatic or hydrophobic interactions with PFAS.

As used herein, the term “Point of Zero Charge” (PZC) generally refers to the pH at which the net surface charge of a solid adsorbent becomes zero. At this pH, the surface may exhibit neither net positive nor negative charge. Understanding the PZC of media components can aid in optimizing conditions for electrostatic interaction with ionic contaminants like PFAS.

As used herein, the term “Porosity” generally refers to the proportion of the total volume of a solid material that is occupied by voids or pores. Porosity may influence the flow rate and residence time of water within a filtration media, and can affect the accessibility of adsorption sites. Higher porosity may increase the contact area between contaminants and media surfaces.

As used herein, the term “Segmental Sampling” generally refers to the procedure of extracting media from discrete vertical intervals within a packed bed for post-treatment analysis. This approach may allow for assessment of spatial distribution, adsorption front progression, or preferential retention locations for specific contaminants.

As used herein, the term “Surface Functionalization” generally refers to the chemical modification of a solid surface to introduce or expose active groups that can participate in contaminant binding. Functionalization may be achieved during material synthesis or through post-treatment modifications.

As used herein, the term “Synergistic Adsorption” generally refers to the enhanced collective removal capacity that may arise when multiple adsorbent components are combined within a single media matrix. For example, interactions between perlite and biochar, or ZVI and clay, may allow simultaneous targeting of long-chain and short-chain PFAS through different physicochemical mechanisms that may not operate effectively in isolation.

As used herein, the term “Zero Valent Iron” (ZVI) generally refers to elemental iron in the oxidation state of zero, which can be used in environmental remediation to remove or reduce contaminants through redox reactions, electrostatic attraction, or surface complexation. ZVI particles may be blended with other media components and can oxidize in situ to release Fe²⁺ and Fe³⁺ ions, facilitating ligand exchange with PFAS molecules.

As used herein, the term “Zeta Potential” generally refers to the electrical potential at the boundary layer between a solid surface and surrounding liquid. This parameter can be used to assess surface charge and colloidal stability, and may influence electrostatic retention of anionic contaminants such as PFAS.

### INCORPORATION BY REFERENCE

[1] Gliige, J., Scheringer, M., Cousins, I. T., DeWitt, J. C., Goldenman, G., Herzke, D., . . . & Wang, Z. (2020). An overview of the uses of per- and polyfluoroalkyl substances (PFAS). Environmental Science: Processes & Impacts, 22(12), 2345-2373.
[2] Gaines, L. G. (2023). Historical and current usage of per- and polyfluoroalkyl substances (PFAS): A literature review. American Journal of Industrial Medicine, 66(5), 353-378.
[3] Joudan, S., & Lundgren, R. J. (2022). Taking the “F” out of forever chemicals. Science, 377(6608), 816-817.
[4] Shrestha, B., Ezazi, M., Ajayan, S., & Kwon, G. (2021). Reversible adsorption and desorption of PFAS on inexpensive graphite adsorbents via alternating electric field. RSC advances, 11(55), 34652-34659.
[5] Hill, P. J., Taylor, M., Goswami, P., & Blackburn, R. S. (2017). Substitution of PFAS chemistry in outdoor apparel and the impact on repellency performance. Chemosphere, 181, 500-507.
[6] Cousins, I. T., Goldenman, G., Herzke, D., Lohmann, R., Miller, M., Ng, C. A., . . . & DeWitt, J. C. (2019). The concept of essential use for determining when uses of PFASs can be phased out. Environmental Science: Processes & Impacts, 21(11), 1803-1815.
[7] Kwak, S. Y., Choi, C. G., & Bae, B. S. (2009). Effect of surface energy on pentacene growth and characteristics of organic thin-film transistors. Electrochemical and Solid-State Letters, 12(8), G37.
[8] Lin, A. Y. C., Panchangam, S. C., & Ciou, P. S. (2010). High levels of perfluorochemicals in Taiwan's wastewater treatment plants and downstream rivers pose great risk to local aquatic ecosystems. Chemosphere, 80(10), 1167-1174.
[9] Joerss, H., Schramm, T. R., Sun, L., Guo, C., Tang, J., & Ebinghaus, R. (2020). Per- and polyfluoroalkyl substances in Chinese and German river water-Point source-and country-specific fingerprints including unknown precursors. Environmental Pollution, 267, 115567.
[10] Sims, J. L., Stroski, K. M., Kim, S., Killeen, G., Ehalt, R., Simcik, M. F., & Brooks, B. W. (2022). Global occurrence and probabilistic environmental health hazard assessment of per- and polyfluoroalkyl substances (PFASs) in groundwater and surface waters. Science of the Total Environment, 816, 151535.
[11] Podder, A., Sadmani, A. A., Reinhart, D., Chang, N. B., & Goel, R. (2021). Per and poly-fluoroalkyl substances (PFAS) as a contaminant of emerging concern in surface water: A transboundary review of their occurrences and toxicity effects. Journal of hazardous materials, 419, 126361.
[12] Griffin, E. K., Aristizabal-Henao, J., Timshina, A., Ditz, H. L., Camacho, C. G., Da Silva, B. F., . . . & Bowden, J. A. (2022). Assessment of per- and polyfluoroalkyl substances (PFAS) in the Indian River Lagoon and Atlantic coast of Brevard County, FL, reveals distinct spatial clusters. Chemosphere, 301, 134478.
[13] Palmer, K., Bangma, J. T., Reiner, J. L., Bonde, R. K., Korte, J. E., Boggs, A. S., & Bowden, J. A. (2019). Per- and polyfluoroalkyl substances (PFAS) in plasma of the West Indian manatee (Trichechus manatus). Marine pollution bulletin, 140, 610-615.
[14] Fragki, S., Dirven, H., Fletcher, T., Grasl-Kraupp, B., Bjerve Gutzkow, K., Hoogenboom, R., . . . & Luijten, M. (2021). Systemic PFOS and PFOA exposure and disturbed lipid homeostasis in humans: what do we know and what not?. Critical reviews in toxicology, 51(2), 141-164.
[15] Gallo, V., Leonardi, G., Genser, B., Lopez-Espinosa, M. J., Frisbee, S. J., Karlsson, L., . . . & Fletcher, T. (2012). Serum perfluorooctanoate (PFOA) and perfluorooctane sulfonate (PFOS) concentrations and liver function biomarkers in a population with elevated PFOA exposure. Environmental health perspectives, 120(5), 655-660.
[16] Coperchini, F., Awwad, O., Rotondi, M., Santini, F. E. R. R. R. U. C. C. I. O., Imbriani, M., & Chiovato, L. (2017). Thyroid disruption by perfluorooctane sulfonate (PFOS) and perfluorooctanoate (PFOA). Journal of endocrinological investigation, 40, 105-121.
[17] Nakayama, S., Harada, K., Inoue, K., Sasaki, K., Seery, B., Saito, N., & Koizumi, A. (2005). Distributions of perfluorooctanoic acid (PFOA) and perfluorooctane sulfonate (PFOS) in Japan and their toxicities. Environmental sciences: an international journal of environmental physiology and toxicology, 12(6), 293-313.
[18] Teaf, C. M., Garber, M. M., Covert, D. J., & Tuovila, B. J. (2019). Perfluorooctanoic acid (PFOA): environmental sources, chemistry, toxicology, and potential risks. Soil and Sediment Contamination: An International Journal, 28(3), 258-273.
[19] Jensen, A. A., & Warming, M. (2015). Short-chain polyfluoroalkyl substances (PFAS). The Danish Environmental Protection Agency.
[20] Solan, M. E., Koperski, C. P., Senthilkumar, S., & Lavado, R. (2023). Short-chain per- and polyfluoralkyl substances (PFAS) effects on oxidative stress biomarkers in human liver, kidney, muscle, and microglia cell lines. Environmental Research, 223, 115424.
[21] Smaili, H., & Ng, C. (2023). Adsorption as a remediation technology for short-chain per- and polyfluoroalkyl substances (PFAS) from water—a critical review. Environmental Science: Water Research & Technology, 9(2), 344-362.
[22] Blake, B. E., Cope, H. A., Hall, S. M., Keys, R. D., Mahler, B. W., McCord, J., . . . & Fenton, S. E. (2020). Evaluation of maternal, embryo, and placental effects in CD-1 mice following gestational exposure to perfluorooctanoic acid (PFOA) or hexafluoropropylene oxide dimer acid (HFPO-DA or GenX). Environmental Health Perspectives, 128(2), 027006.
[23] Liu, S., Yang, R., Yin, N., & Faiola, F. (2020). The short-chain perfluorinated compounds PFBS, PFHxS, PFBA and PFHxA, disrupt human mesenchymal stem cell self-renewal and adipogenic differentiation. Journal of Environmental Sciences, 88, 187-199.
[24] Per- and Polyfluoroalkyl Substances (PFAS) Final PFAS National Primary Drinking Water Regulation, https://www.epa.gov/sdwa/and-polyfluoroalkyl-substances-pfas.
[25] Ordonez, D., Valencia, A., Pereira, B., & Chang, N. B. (2022). Color removal for large-scale interbasin water transfer: Experimental comparison of five sorption media. Environmental Research, 212, 113208.
[26] Islam, M. T., Valencia, A., Ordonez, D., Sadmani, A. A., & Chang, N. B. (2023). The effect of green sorption media pretreatment on nanofiltration during water treatment for long- and short-chain per- and polyfluoroalkyl substances (PFAS) removal. Separation and Purification Technology, 324, 124548.
[27] Vakili, M., Bao, Y., Gholami, F., Gholami, Z., Deng, S., Wang, W., . . . & Yu, G. (2021). Removal of HFPO-DA (GenX) from aqueous solutions: A mini-review. Chemical Engineering Journal, 424, 130266.
[28] Lee, T., Speth, T. F., & Nadagouda, M. N. (2022). High-pressure membrane filtration processes for separation of Per- and polyfluoroalkyl substances (PFAS). Chemical Engineering Journal, 431, 134023.
[29] Liu, Y., Li, T., Bao, J., Hu, X., Zhao, X., Shao, L., . . . & Lu, M. (2022). A review of treatment techniques for short-chain perfluoroalkyl substances. Applied Sciences, 12(4), 1941.
[30] Longendyke, G. K., Katel, S., & Wang, Y. (2022). PFAS fate and destruction mechanisms during thermal treatment: a comprehensive review. Environmental Science: Processes & Impacts, 24(2), 196-208.
[31] Mastropietro, T. F., Bruno, R., Pardo, E., & Armentano, D. (2021). Reverse osmosis and nanofiltration membranes for highly efficient PFASs removal: overview, challenges and future perspectives. Dalton Transactions, 50(16), 5398-5410.
[32] Tang, C. Y., Fu, Q. S., Criddle, C. S., & Leckie, J. O. (2007). Effect of flux (transmembrane pressure) and membrane properties on fouling and rejection of reverse osmosis and nanofiltration membranes treating perfluorooctane sulfonate containing wastewater. Environmental science & technology, 41(6), 2008-2014.
[33] Fagbayigbo, B. O., Opeolu, B. O., & Fatoki, O. S. (2020). Adsorption of perfluorooctanoic acid (PFOA) and perfluorooctane sulfonate (PFOS) from water using leaf biomass (Vitis vinifera) in a fixed-bed column study. Journal of Environmental Health Science and Engineering, 18, 221-233.
[34] Rodrigo, P. M., Navarathna, C., Pham, M. T., McClain, S. J., Stokes, S., Zhang, X., . . . & Mlsna, T. E. (2022). Batch and fixed bed sorption of low to moderate concentrations of aqueous per- and poly-fluoroalkyl substances (PFAS) on Douglas fir biochar and its Fe₃O₄ hybrids. Chemosphere, 308, 136155.
[35] Liu, N., Wu, C., Lyu, G., & Li, M. (2021). Efficient adsorptive removal of short-chain perfluoroalkyl acids using reed straw-derived biochar (RESCA). Science of the total environment, 798, 149191.
[36] Cheng, J., Odeh, M., Lecompte, A. R., Islam, T., Ordonez, D., Valencia, A., . . . & Chang, N. B. (2024). Simultaneous removal of nutrients and biological pollutants via specialty absorbents in a water filtration system for watershed remediation. Environmental Pollution, 349, 123903.
[37] Ordonez, D., Podder, A., Valencia, A., Sadmani, A. A., Reinhart, D., & Chang, N. B. (2022). Continuous fixed-bed column adsorption of perfluorooctane sulfonic acid (PFOS) and perfluorooctanoic acid (PFOA) from canal water using zero-valent Iron-based filtration media. Separation and Purification Technology, 299, 121800.
[38] Valencia, A., Ordonez, D., Sadmani, A. A., Reinhart, D., & Chang, N. B. (2023). Comparing the removal and fate of long and short chain per- and polyfluoroalkyl substances (PFAS) during surface water treatment via specialty adsorbents. Journal of Water Process Engineering, 56, 104345.
[39] Ordonez, D., Valencia, A., Cheng, J., & Chang, N. B. (2023). Exploring the differential effect of adsorption ingredients in three green sorption media for phosphorous removal from river water. Journal of Water Process Engineering, 55, 104073.
[40] Stevens, P. W., Paperno, R., Beal, J. L., MacDonald, T. C., Miller, H. N., Klarmann, P. A., & Malinowski, C. R. (2023). Identification of fish habitat hotspots for use in prioritizing conservation and restoration projects in coastal rivers. Environmental Biology of Fishes, 106(2), 221-235.
[41] Harris, J. T., de la Garza, G. D., Devlin, A. M., & McNeil, A. J. (2022). Rapid removal of poly- and perfluoroalkyl substances with quaternized wood pulp. ACS ES&T Water, 2(2), 349-356.
[42] MarvinSketch. (2023). Marvin version 23.4, 2023, ChemAxon (http://www.chemaxon.com). (n.d.). Retrieved Aug. 27, 2023, from https://chemaxon.com/marvin.
[43] Rosenblum, L., & Wendelken, S. C. (2019). Method 533: determination of per- and polyfluoroalkyl substances in drinking water by isotope dilution anion exchange solid phase extraction and liquid chromatography/tandem mass spectrometry. Tandem Mass Spectrometry, 52.
[44] Mahmood, T., Saddique, M. T., Naeem, A., Westerhoff, P., Mustafa, S., & Alum, A. (2011). Comparison of different methods for the point of zero charge determination of NiO. Industrial & Engineering Chemistry Research, 50(17), 10017-10023.
[45] Ordonez, D., Valencia, A., Chang, N. B., & Wanielista, M. P. (2020). Synergistic effects of aluminum/iron oxides and clay minerals on nutrient removal and recovery in water filtration media. Journal of cleaner production, 275, 122728.
[46] Thomas, H. C. (1944). Heterogeneous ion exchange in a flowing system. Journal of the American chemical society, 66(10), 1664-1666.
[47] Yoon, Y. H., & Nelson, J. H. (1984). Application of gas adsorption kinetics I. A theoretical model for respirator cartridge service life. American industrial hygiene association journal, 45(8), 509-516.
[48] Yan, G., Viraraghavan, T., & Chen, M. (2001). A new model for heavy metal removal in a biosorption column. Adsorption Science & Technology, 19(1), 25-43.
[49] Chowdhury, Z. Z., Abd Hamid, S. B., & Zain, S. M. (2015). Evaluating design parameters for breakthrough curve analysis and kinetics of fixed bed columns for Cu (II) cations using lignocellulosic wastes. BioResources, 10(1), 732-749.
[50] Chigbu, P. E., Ukaegbu, E. C., & Nwanya, J. C. (2009). On comparing the prediction variances of some central composite designs in spherical regions: A review. Statistica, 69(4), 285-298.
[51] Jiao, W., Li, X., Zhan, M., Wu, R., Shan, Y., Zhang, C., . . . & Giesy, J. (2022). Dimensionless parameters and numbers controlling PFAS transport in unsaturated porous media.
[52] Smith, J. W. N., Beuthe, B., Dunk, M., Demeure, S., Carmona, J. M. M., Medve, A., . . . & Slenders, H. (2016). Environmental fate and effects of polyand perfluoroalkyl substances (PFAS). CONCAWE Reports, 8, 1-107.
[53] Lei, X., Lian, Q., Zhang, X., Karsili, T. K., Holmes, W., Chen, Y., . . . & Gang, D. D. (2023). A review of PFAS adsorption from aqueous solutions: Current approaches, engineering applications, challenges, and opportunities. Environmental Pollution, 321, 121138.
[54] Campillo-Cora, C., Santias-Miguel, V., Nunez-Delgado, A., Arias-Estevez, M., & Fernindez-Calvino, D. (2022). Presence, fate, and transport of sulfonylurea herbicides in soils. In Pesticides Remediation Technologies from Water and Wastewater (pp. 23-53). Elsevier.
[55] Wang, F., Liu, C., & Shih, K. (2012). Adsorption behavior of perfluorooctanesulfonate (PFOS) and perfluorooctanoate (PFOA) on boehmite. Chemosphere, 89(8), 1009-1014.
[56] Gao, X., & Chorover, J. (2012). Adsorption of perfluorooctanoic acid and perfluorooctanesulfonic acid to iron oxide surfaces as studied by flow-through ATR-FTIR spectroscopy. Environmental Chemistry, 9(2), 148-157.
[57] Parenky, A. C., Gevaerd de Souza, N., Asgari, P., Jeon, J., Nadagouda, M. N., & Choi, H. (2020). Removal of perfluorooctanesulfonic acid in water by combining zerovalent iron particles with common oxidants. Environmental Engineering Science, 37(7), 472-481.
[58] Yu, Q., Zhang, R., Deng, S., Huang, J., & Yu, G. (2009). Sorption of perfluorooctane sulfonate and perfluorooctanoate on activated carbons and resin: Kinetic and isotherm study. Water research, 43(4), 1150-1158.
[59] Fitzgerald, N. J., Wargenau, A., Sorenson, C., Pedersen, J., Tufenkji, N., Novak, P. J., & Simcik, M. F. (2018). Partitioning and accumulation of perfluoroalkyl substances in model lipid bilayers and bacteria. Environmental science & technology, 52(18), 10433-10440.
[60] Vo, H. N. P., Nguyen, T. M. H., Ngo, H. H., Guo, W., & Shukla, P. (2022). Biochar sorption of perfluoroalkyl substances (PFASs) in aqueous film-forming foams-impacted groundwater: Effects of PFASs properties and groundwater chemistry. Chemosphere, 286, 131622.
[61] Guo, W., Huo, S., Feng, J., & Lu, X. (2017). Adsorption of perfluorooctane sulfonate (PFOS) on corn straw-derived biochar prepared at different pyrolytic temperatures. Journal of the Taiwan Institute of Chemical Engineers, 78, 265-271.
[62] Aboughaly, M., & Fattah, I. M. R. (2023). Production of Biochar from Biomass Pyrolysis for Removal of PFAS from Wastewater and Biosolids: A Critical Review.
[63] Ahmad, M., Rajapaksha, A. U., Lim, J. E., Zhang, M., Bolan, N., Mohan, D., . . . & Ok, Y. S. (2014). Biochar as a sorbent for contaminant management in soil and water: a review. Chemosphere, 99, 19-33.
[64] Elkhalifa, S., Mackey, H. R., Al-Ansari, T., & McKay, G. (2022). Pyrolysis of biosolids to produce biochars: a review. Sustainability, 14(15), 9626.
[65] Uzunova, S., Angelova, D., Anchev, B., Uzunov, I., & Gigova, A. (2014). Changes in structure of solid pyrolysis residue during slow pyrolysis of rice husk. Bulg Chem Commun, 46(1), 184.
[66] Xu, X., Zhao, Y., Sima, J., Zhao, L., Masek, O., & Cao, X. (2017). Indispensable role of biochar-inherent mineral constituents in its environmental applications: A review. Bioresource Technology, 241, 887-899.
[67] Li, H., Dong, X., da Silva, E. B., de Oliveira, L. M., Chen, Y., & Ma, L. Q. (2017). Mechanisms of metal sorption by biochars: Biochar characteristics and modifications. Chemosphere, 178, 466-478.
[68] Navarathna, C., Keel, M. G., Rodrigo, P. M., Carrasco, C., Ramirez, A., Jamison, H., . . . & Mlsna, T. E. (2022). Biochar and biochar composites for poly- and perfluoroalkyl substances (PFAS) sorption. In Sustainable Biochar for Water and Wastewater Treatment (pp. 555-595). Elsevier.
[69] Ameloot, N., Graber, E. R., Verheijen, F. G., & De Neve, S. (2013). Interactions between biochar stability and soil organisms: review and research needs. European Journal of Soil Science, 64(4), 379-390.
[70] Zhang, Y., Thomas, A., Apul, O., & Venkatesan, A. K. (2023). Coexisting ions and long-chain per- and polyfluoroalkyl substances (PFAS) inhibit the adsorption of short-chain PFAS by granular activated carbon. Journal of Hazardous Materials, 460, 132378.
[71] Xiao, J., Huang, J., Wang, Y., Qian, X., & Cao, M. (2022). Evaluation of the ecological impacts of short- and long-chain perfluoroalkyl acids on constructed wetland systems: Perfluorobutyric acid and perfluorooctanoic acid. Journal of Hazardous Materials, 435, 128863.
[72] Maimaiti, A., Deng, S., Meng, P., Wang, W., Wang, B., Huang, J., . . . & Yu, G. (2018). Competitive adsorption of perfluoroalkyl substances on anion exchange resins in simulated AFFF-impacted groundwater. Chemical Engineering Journal, 348, 494-502.
[73] Pramanik, B. K., Pramanik, S. K., & Suja, F. (2015). A comparative study of coagulation, granular- and powdered-activated carbon for the removal of perfluorooctane sulfonate and perfluorooctanoate in drinking water treatment. Environmental technology, 36(20), 2610-2617.
[74] Jeon, J., Kannan, K., Lim, B. J., An, K. G., & Kim, S. D. (2011). Effects of salinity and organic matter on the partitioning of perfluoroalkyl acid (PFAs) to clay particles. Journal of Environmental Monitoring, 13(6), 1803-1810.
[75] Stebel, E. K., Pike, K. A., Nguyen, H., Hartmann, H. A., Klonowski, M. J., Lawrence, M. G., . . . & Edmiston, P. L. (2019). Absorption of short-chain to long-chain perfluoroalkyl substances using swellable organically modified silica. Environmental Science: Water Research & Technology, 5(11), 1854-1866.
[76] Riegel, M., Haist-Gulde, B., & Sacher, F. (2023). Sorptive removal of short-chain perfluoroalkyl substances (PFAS) during drinking water treatment using activated carbon and anion exchanger. Environmental Sciences Europe, 35(1), 12.
[77] Luo, L., Zhang, S., Ma, Y., Christie, P., & Huang, H. (2008). Facilitating effects of metal cations on phenanthrene sorption in soils. Environmental science & technology, 42(7), 2414-2419.
[78] Cai, W., Navarro, D. A., Du, J., Ying, G., Yang, B., McLaughlin, M. J., & Kookana, R. S. (2022). Increasing ionic strength and valency of cations enhance sorption through hydrophobic interactions of PFAS with soil surfaces. Science of the Total Environment, 817, 152975

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A filtration medium treating water matrices, the filtration medium comprising:
(a) biochar;
(b) perlite;
(c) sand;
(d) zero-valent iron (ZVI);
(e) wherein the filtration media is configured to remove a plurality of substances, the plurality of substances comprising per- and polyfluoroalkyl substances (PFAS), perfluorooctanesulfonic acid (PFOS), perfluorobutanoic acid (PFBA), perfluorobutane sulfonic acid (PFBS)), and a combination of thereof; and
(f) wherein the plurality of substances comprise varying chain lengths and polarities, whereby the filtration media targets at least one of the plurality of substances by at least hydrophobic interaction, electrostatic attraction, and ligand exchange.

2. The filtration medium of claim 1, wherein the biochar has a point of zero charge greater than 9.0.

3. The filtration medium of claim 2, wherein the biochar has a BET surface area of at least 300 m²/g.

4. The filtration medium of claim 3, wherein the biochar is derived from hardwood biomass subjected to pyrolysis.

5. The filtration medium of claim 1, wherein the ZVI is derived from recycled iron filings.

6. The filtration medium of claim 1, wherein the sand comprises from 60% to 90% by weight of the total composition.

7. The filtration medium of claim 1, further comprising clay configured to provide pH buffering between pH 6.5 and 7.5.

8. The filtration medium of claim 7, wherein the pH-buffering effect is sufficient to maintain bed pH stability for at least 24 hours of flow-through operation.

9. The filtration medium of claim 5, wherein the ZVI provides local reducing conditions favoring ligand exchange with PFAS compounds.

10. A method for treating water matrices, the method comprising:
(a) directing water matrices through a packed bed comprising a granular mixture of adsorptive materials;
(b) wherein the adsorptive materials comprise biochar, perlite, sand, clay, and zero-valent iron (ZVI);
(c) wherein the water matrices comprise a plurality of substances, the plurality of substances comprising both long-chain and short-chain lengths, whereby the plurality of substances include per- and polyfluoroalkyl substances (PFAS), perfluorooctanesulfonic acid (PFOS), perfluorobutanoic acid (PFBA), perfluorobutane sulfonic acid (PFBS)), and a combination of thereof;
(d) wherein at least one of the plurality of substances is retained by the packed bed by a combination of hydrophobic, electrostatic, and ligand-exchange interactions; and
(e) wherein the packed bed is operated under gravity-fed flow conditions without external pressurization.

11. The method of claim 10, wherein at least one of the plurality of long chain substances is retained in an upper portion of the packed bed and at least one of the plurality of short chain substances migrates downstream to a lower portion of the packed bed.

12. The method of claim 11, wherein the packed bed is installed in a gravity-fed vertical column.

13. The method of claim 12, wherein the packed bed is compositionally homogeneous across its depth.

14. The method of claim 13, wherein a mobility and a spatial separation of the plurality of substances are confirmed by segmental sampling of the bed after use.

15. The method of claim 10, wherein the sand comprises from 60% to 90% by weight of the total composition.

16. The method of claim 15, wherein the water comprises background ionic species that enhance the retention of at least one of the plurality of substances by the adsorptive materials.

17. The method of claim 12, wherein the packed bed is installed within a removable treatment cartridge.

18. A filtration system, the filtration system comprising:
(a) a vertically oriented housing having an inlet and an outlet;
(b) a packed bed disposed within the housing, the packed bed comprising a homogeneous or layered bed of biochar, perlite, sand, clay, and zero-valent iron (ZVI);
(c) wherein a plurality of substances comprising a plurality of chain lengths are retained at varying depths within the packed bed during flow-through treatment;
(d) wherein at least one of the plurality of substances comprising long-chain lengths is retained predominately in an upstream portion of the packed bed and at least one of the plurality of substances comprising short-chain lengths migrate to a downstream portion; and
(e) wherein the housing is configured to allow access to discrete vertical segments of the bed for sampling.

19. The filtration system of claim 18, wherein sampling from the top and bottom of the packed bed indicates a higher plurality of short-chain length substances in the downstream portion relative to the upstream portion.

20. The filtration system of claim 18, wherein the plurality of substances comprise per- and polyfluoroalkyl substances (PFAS), perfluorooctanesulfonic acid (PFOS), perfluorobutanoic acid (PFBA), perfluorobutane sulfonic acid (PFBS)), and a combination of thereof.
